(19) United States
(12) Patent Application Publication
(10) Pub. No.: US 2010/0318415 A1
(43) Pub. Date: Dec. 16, 2010

(54) System and method facilitating purchase of goods and services by pre-payment via a universal gift or other pre-paid card with incentives

(76) Inventor: Mel David Gottlieb, Rose Bay (GB)

Correspondence Address: BERRY & ASSOCIATES P.C., 9229 SUNSET BOULEVARD, SUITE 630, LOS ANGELES, CA, 90069, US

(21) Appl. No.: 12/456,114

(22) Filed: Jun. 10, 2009

(51) Int. Cl. G06Q 40/00; G07F 19/00; G06Q 30/00; G06Q 50/00; G06Q 20/00

(52) U.S. Cl. 705/14.17; 235/379; 705/41; 705/17

(57) ABSTRACT

A system and method for facilitating purchase of goods and services by pre-payment via a universal gift or other pre-paid card with incentives. The universal gift or other pre-paid card provides incentives to vendors and consumers that use it. It permits flexible purchase of goods and services by consumers. The consumers are recipients of the universal gift card from others or purchasers of the universal gift card who decide to use the card themselves. The universal gift card is usable at any one of a plurality of merchants who are designated and authorized by the system. The universal gift card permits purchase up to a specified amount, which must be paid by a consumer prior to its use. The specified amount is either maintained on the universal gift card itself or is maintained on a database associated with the system, which maintains associated accounts and controls its use. The universal gift card preferably has few restrictions (e.g. expiration date), if any, to facilitate ease of use by consumers. Among the incentives provided is the ability to designate preferences, such as provide a percentage of specified amounts to charitable donations and to reduce transaction costs that are often associated with payment methods other than use of hard physical currency.

### BACKGROUND OF THE INVENTION

1. Field of the Invention

The present invention relates generally to the field of systems and methods for purchase of goods, services or both, by use of pre-paid techniques that are electronic or other. More particularly, the present invention relates to a system and method by which a universal gift or pre-paid card with incentives, facilitates quick and easy transactions for users in commerce. The incentives include flexible use with many vendors, transferability to parties designated by recipient, designation of preferences including charitable donations by vendors or recipients, no unreasonable expiration dates etc. For purposes of this application, this card is referred to as a universal gift card, however, by no means is the use of this universal card simply for giving of gifts. The value of the universal gift card that is available for a transaction is pre-established or pre-paid by the user.

2. Background of the Invention

Various methods of pre-established and pre-paid payment systems and schemes exist today, including gift cards, prepaid telephone cards, or the like. More and more, people purchase gift cards instead of purchasing gifts, rewards, or prizes or instead of giving hard currency. Such prepaid and gift cards take various forms. By way of one example, a pre-paid value purchased by a user or consumer is carried on some device. By way of another example, a consumer carries a card with some identification of an account or record, which has a value associated with it.

These existing systems and methods offer limited advantages and therefore, so far, have limited use in commerce. For example, most commonly, gift cards allow funds to be used only at a single vendor, or at best, vendors within the same business group or location, such as a shopping mall. Typically, gift cards or gift certificates can only be redeemed with the associated vendor that supplied the card. Another example of a gift card that exists today is the Visa or Master Card gift card, which functions similar to a credit card. It has a stored value associated with a customer's Visa or Master card account. Such Visa and Master cards may be used at locations that accept a Visa or Master card. A significant drawback with these cards is that they have the same high transaction fees associated with normal credit card use. Furthermore, these Visa and Master card gift cards do not provide any incentives or advantage to encourage their use.

A common implementation of stored value devices in commerce are telephone cards that hold the value accorded to the card on the card itself. Such stored value devices are generally treated in the same manner as hard currency. However, unlike hard currency, they can only be used on compatible phones and phones operating within specific networks. Vendors typically employ various incentive programs to encourage use of such telephone cards, by offering either store specific cards, through branded credit cards or debit cards. These incentive programs, in general, carry some point or value accrual mechanism, which is based on purchasing patterns of consumers and accords them some later advantage. Such programs coax consumers to patronize certain vendors or merchants or adopt a particular payment method. Examples of such cards are credit cards associated with airlines. With these, cardholders typically earn frequent flier miles for every dollar or other designated amount of currency that is spent. The amount of miles earned is typically determined by the vendor or the nature of the purchase. Although these cards accord consumers some incentives for use, one drawback of such cards as they exist today is that they are vendor specific. Consumers must carry many different dedicated cards or establish their alliances with particular vendors at the outset, which is cumbersome, inconvenient, and restricting.

By way of another example, Bank of America offers specific payment systems by its “Keep the Change” program, which takes consumer debit purchases and rounds up the purchases to the nearest dollar and places the difference in a personal savings account. This is designed to provide an incentive for customers to use their debit card instead of a credit card.

Clearly, credit cards are not examples of pre-paid payment schemes. Rather, they allow customers to charge balances that they are required to pay later. Debit cards also require individual accounts at a bank and though they have a pre-established balance associated with them, they are tied to specific users and are not meant to be given or transferred to others.

Interestingly, for consumers who are motivated to provide philanthropic donations, there currently exist no methods for pre-established donation schemes. Rather, there are only three methods by which a consumer can purchase products and donate to a charity at the same time. First, some credit card companies have a branding agreement with a particular philanthropy, and donate a percentage of what is spent on a credit card to the particular philanthropy. Second, a particular philanthropy may receive a percentage of the transaction fees of the cards that carry their branding. However, neither of these two methods are pre-paid systems. Nor do they allow for easy giving and transferring of the card to another party. The third method is by which a gift card is simply designated by a particular charity.

In addition, at present, the world is moving towards greater free trade with an important global economy. At the same time, there is a rapid increase in income disparities throughout the world. To address the first of the above two situations, there is a growing need for a ubiquitous method of payment that can be used around the world with little overhead or additional expense.

With respect to the second situation, not only are there increased disparities in income, charitable donations are on the decline for many reasons. There is a marked decrease in funding by governments around the world for various philanthropic pursuits. Governments around the world are faced with extreme economic concerns, as a consequence of which charity is simply not a priority. Due to the same economic concerns, large global conglomerates, once dedicated to giving, have also decreased their charitable donations. More and more, organizations and individuals are donating less because they are facing tough economic times. However, at the same time, more and more people and organizations require charity.

Unfortunately, even those that are dedicated to charitable endeavors have few incentives or systems and methods in place to pursue such endeavors. Companies and charities have little control to push such endeavors.

For these reasons and many more that are not addressed here, there is great need for a creative system or method in commerce, which facilitates charity with little or no extra cost to the parties transacting business in commerce. A system or method is needed that would efficiently and flexibly conduct business for vendors and consumers alike, yet provide charity where needed. There is great need for a system and method that issues and facilitates use of a universal gift or other pre-paid card that may be used with a plurality of vendors or groups of vendors that are authorized, has few if any restrictions, and offers many incentives to the vendors and the consumers alike.

It would be desirable to have a system and method that could easily provide incentives for prepaid cards with a pre-established or pre-paid value as are common for credit and debit cards. It would be desirable to provide an efficient, equitable, motivating, and high-yielding method of providing donations to charities to not only increase charity, but also allow ease of conducting charity by automatic donations with customary purchases. This would ensure a reliable and constant source of philanthropic donations.

It would also be desirable to provide a universal system that could facilitate taking automatic donations of a predetermined percentage from the funds used for purchases and direct those donations to charitable preferences designated by either the consumers, or the vendors, or any other party. It would also be desirable for the charitable donation portion of the funds (and any associated administrative costs) to be simply deducted from the value of a user purchase that is credited to the merchant. Therefore, when a user spends funds on daily purchases or the like, a portion of those funds is simply directed to charity, providing both the merchants and the consumers with benefits and incentives. In such cases, the merchant can receive tax credits for making the charitable donations, when applicable, based on the tax regulations of the particular country where the merchant is based.

### SUMMARY OF THE INVENTION

The present invention relates to a system and method involving use of computer systems and communications systems for purchase of goods, services, or both, in commerce, by pre-funded or pre-paid payment mechanisms using universal payment or gift cards that are electronic or other. The system and method facilitates transactions in commerce and facilitates quick and easy transactions for users in commerce. The incentives include flexible use with many vendors, transferability to parties designated by recipient, designation of preferences including charitable donations by vendors or recipients, no unreasonable expiration dates etc. For the purpose of this application, this universal payment card is referred to as a “universal gift card,” but it should be recognized that such a card may be used in commerce for purposes other than providing a gift to another. It may be used by cardholders themselves to serve as a pre-paid mechanism for payment.

In one preferred embodiment, the universal gift card is configured with no restrictions to facilitate ease of use and to avoid the complications typically associated with restrictions. Its use is flexible and allows users or consumers to make purchases or transact business with any vendor that is pre-established as one of the authorized vendors. A vendor as referred to in this application includes a merchant, seller, or any other party, entity, or organization representing or marketing one or more of such vendors either directly or indirectly. The universal gift card can be acquired either directly or indirectly from vendors via direct or indirect marketing techniques, including direct or indirect mail, electronically, in catalogs, magazines, or the like, designed to reach consumers. Vendors may distribute their own universal gift cards, or universal gift cards of other vendors, organizations, etc.

The universal gift card is configured for flexible transactions. For example, in some cases, the universal gift card is configured with no expiration date, provided it is used within a reasonable time limit. Of course, in the event a particular vendor desires some restrictions, the universal gift card facilitates such variations.

A universal gift card in accordance with the present invention encourages a free economic environment and allows a user to use the card and its associated funds at a time convenient for the user and when the user can derive the most financial benefit from it. In addition, in accordance with the system and method of the present invention, the universal payment or gift card may be obtained from any vendor.

Also, in accordance with the system and method of the present invention, the universal payment or gift card is easily and fully transferable to any recipient. For example, it can be shared among friends and family members of the recipient or any party that the recipient designates the universal card to.

In one specific embodiment, the universal gift card includes many features and offers many incentives. One feature and incentive is that with use of the universal gift card, a predetermined amount of the value of the universal gift card is automatically donated to one or more of a pre-defined group of charities. The pre-defined group of charities that receive the donations are preferably pre-established by preferences. The system and method permits either the consumer that purchased the universal gift card, the recipient of the universal gift card, or the merchant that issued the card, to pre-establish the one or more entities that receive the donations. The system and method permits various fractions of the percentage of the value of each universal gift card to be designated and conveyed to different charities. In addition, the system accords various tax advantages based on such charitable donations to either the vendors that issued the universal gift cards or the merchants where the funds are ultimately spent, depending on the arrangements that are established with the system. For example, the charitable donation portions of the funds (and any associated administrative costs) can simply be deducted from the value of a user purchase that is credited to the merchant. Therefore, the merchant with whom a user spends funds associated with the universal gift card, makes the charitable donation. In such case, the merchant receives the tax credit for making that charitable donation. In some embodiments, a tax credit for a charitable donation may be variously divided between the parties involved in a transaction, for example, the merchant, the purchaser, and the ultimate recipient. In some situations, the system accommodates charitable designations by a user, different from the recipient.

In accordance with another feature of the specific embodiment, the universal gift card offers purchasing incentives whereby a consumer, recipient of the universal card, or provider of the card, defines certain purchase preferences. One preference allows certain discounts with certain merchants. Another preference allows certain discounts for specific products. Yet another preference allows certain discounts at designated times, for example, the holidays, such as Christmas etc. Merchants can use the universal gift card system to define certain incentives or exchanges to promote purchases at their establishments. The money or funds to be donated can be garnered in a number of ways, for example, by allocating a given percentage of the transaction costs. Alternatively, the reduction in processing fees and operating costs accomplished by this system and method can be directed to the charitable donations. Yet another possibility is that based on merchant agreements that provide incentives for customers to purchase from them, a portion of the merchant increased sales may be directed to charitable donations.

In yet another embodiment of the present invention, the value designation assigned to a universal gift card is stored on the card itself. In this embodiment, the universal gift card is a stored value or smart card that stores the actual preferences (for the merchant, consumer, or recipient) associated with the card, which are adjusted and updated as the card is used. The card, as it is used, interacts with a control unit, which monitors and regulates its use.

A consumer can obtain a universal gift card by purchasing a card (which includes the operation of designating a value to the card) from an authorized third party (vendor, merchant, or seller). A vendor may be a web merchant, auction site, web-based payment system, financial or insurance institution, retail merchant, sales persons such as insurance sales members, charities, utilities, telecommunication companies, or the like. The universal gift cardholder may be an initial buyer, or a buyer to whom the card is transferred or gifted. Rather than acquired by purchase, it may be gifted or otherwise given to consumers by a vendor as some sort of prize or promotion. Vendors are able to specify certain preferences for use of the universal gift card.

A charitable institution may provide the card directly to consumers to solicit charitable contributions directly from these consumers. A buyer of the universal card from a vendor may also designate certain preferences such as a particular charity. Further, in some instances, vendors and or cardholders may prescribe certain preferences that dictate how the universal card may be used, for example, the location or toward the purchase of only certain items. In some instances, charities may be designated at the time of purchase of the universal gift card, which may be credited immediately. Alternatively, charities may receive the funds donated at other times. The system and method in accordance with the present invention is configured to accommodate many variations.

In accordance with another embodiment, the system and method uses an identifier that indicates a record that is held by a control unit within the system. The system may be operated by one or more of any number of institutions responsible for maintaining and tracking use of the universal gift cards by consumers, merchants, and recipients. In this embodiment, the value designated to the universal cards is stored in memory (within one or more databases, configured separately or together) rather than held on the universal payment card itself. The universal gift card carries the identifier (as a visual or concealed indicia), which is used to link the universal card to an associated record in the system's memory. When making a purchase, a user typically provides account information and required verification information. The price to be charged is then determined based on stored preferences that are retrieved by the merchant. At this time, the system permits donations and other incentives to be applied based on the user preferences. The present system provides greater ease of use by consumers, reduced fraud, transfer of unused funds or earned discounts to other universal cards that are purchased.

In accordance with yet another feature, different electronic designations based on agreements and preferences between merchants and the system are stored. A user can go to various stores where each store offers a different exchange or a different rate of donating to charities depending upon the arrangements negotiated with different merchants.

In accordance with yet another feature, the universal gift card is designated for use in a specific currency or in different currencies. Additionally, the value stored either on the universal gift card device itself or in an account associated with it, does not need to be represented as an actual currency value, i.e., dollars, yen, yuan, etc., but rather may be stored as a credit value, which can easily be converted into any currency. By use of credits instead of actual hard currency, the system increases international ubiquity and eliminates the current charges associated with performing currency exchanges through current modern banking networks and systems. In addition, the furnishing institution maintains some basket of currencies, in order to maintain exchange rates for the credits stored with a real currency. In the event the universal gift card is used in different countries, the system includes a currency converter that provides the remaining balance to the user of the gift card in the appropriate currency.

In yet another feature, the system facilitates adding value to the universal gift card. In one embodiment, a user is able to obtain a record for allocating value simply by accessing and navigating to an appropriate website, via a personal computer or the like, filling out a form and providing money in any standard way, through a credit card, a debit card, an electronic bank transfer, a wire, through the mailing of a check, money order, cash, etc. Users, via the website, maintain their account preferences. Users may make printouts that present the necessary account information needed for performing a transaction. The print outs provide ways of communicating the information, such as with barcodes, or simple human readable devices, to the designated hardware in the system. The system and method facilitates provision of the universal gift card to users that order them or users that are enrolled with some promotion or website. The cards are printed with the necessary information by downloading data on a smart card, or providing it by printing a bar code, magnetic strip, or the like.

In another embodiment, a user performs the same actions as via the internet described above, over the phone, with an automated operator system or via interaction with a human interface. In an embodiment of the system that involves use of a stored value device, such as a smart card, data between the stored value device and the system is communicated in various ways. For example, a user inserts the smart card into a receptacle in a payphone, network-attached device or at the merchant site, whereby the device can then be updated with the desired amount. In this embodiment, a card holder is able to simply modify the associated preferences without any external connection. Upon use, the preferences are conveyed to a control unit.

With both the stored-value device and the account-based systems, merchants handle the funds account in different ways. In the account-based system, the funds account represents a guarantee. The control unit communicates a guarantee to the merchants that the funds are available and in some way be transferred to them. The easiest mechanism by which the funds are transferred to the merchant include the merchant establishing an account with the control unit, allowing for the funds to be directly transferred from the record referenced by the card to a record held by the merchant. Alternatively, funds are electronically transferred to an account held by another bank or funding institution or the funds are physically sent to the merchant.

In the embodiment in which the universal gift card stores the value, the value as stored is considered a currency. In this case, merchants simply accept the value and essentially take ownership of the “credits” by transferring the credits from the card to their own system. These “credits” are then used as a currency by the merchant. Alternatively, the merchants simply exchange the credits with the control unit, whereby the control unit furnishes the credits to the device in exchange for payment from the buyer for real currency. The control unit services the stored value device not unlike a backing institution, such as governments that back currencies. The control unit is not limited to private banks or institutions, but may represent government institutions, or possibly an international coalition of sorts holding some basket of currencies.

In accordance with yet another feature, users of the universal gift card register with the system providing identification information. In the event users lose the universal gift card, they can use their mobile phones to provide identification (for example their MIN (mobile identification numbers)), access their account, and pull their profiles and records, including the remaining balance.

Additional features and advantages of the invention are set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as described here.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore, to be considered to be limiting of its scope, the invention will be described and explained with additional specificity and detail through the use of the accompanying drawings in which:

FIG. 1 is a schematic representation of one embodiment of the entire system including a universal gift card in accordance with the present invention, with which purchases and related transactions are performed over communication (e.g. internet) connections;

FIG. 2 is a schematic representation of a system in accordance with another embodiment of the present invention in which universal gift card purchases and related transactions are performed over communication systems that use secured transaction networks;

FIG. 3 is a flow diagram that illustrates the process by which, a pre-payment scheme of an exemplary method of the present invention that involves the use of a universal payment or gift card having an associated record is obtained and configured in commerce;

FIG. 4a is a flow diagram illustrating the process by which, a pre-payment scheme of an exemplary method of the present invention (using a universal payment or gift card also of the present invention) stores a designated value, and is obtained (e.g., by purchase) and configured in commerce;

FIG. 4b is a flow diagram illustrating the process by which, a universal payment or gift card with a stored value interacts with a control unit of an illustrated embodiment of the system;

FIG. 4c is a flow diagram illustrating the process by which, sellers obtain the value to be stored on the universal payment or gift card from the control unit of the illustrated system;

FIG. 5 is a flow diagram illustrating the steps involved in the use of the universal payment or gift card to make purchases;

FIG. 6 is a flow diagram illustrating the steps involved in the use of the universal payment or gift card where the card itself stores a designated value;

FIG. 7 is an illustrative diagram that depicts the possible methods and operations of the system by which a merchant (seller or vendor) obtains record identification information from a universal payment or gift card;

FIG. 8 is an illustrative diagram that depicts the steps by which a universal gift card is associated with a stored value;

FIG. 9 is a flow diagram representing the operations of the illustrated system that update, add, or maintain value, preference, or both, on an account associated with the universal payment or gift card;

FIG. 10a is a flow diagram representing the system operations that update, add, or maintain value, preferences, or both, that are stored on a universal payment or gift card itself; and

FIG. 10b is a flow diagram representing the system operations that update, add, or maintain value, preferences, or both, associated with a universal payment or gift card; the operations involving interfaces between the universal gift card and the control unit.

FIG. 11 is a block diagram representation that illustrates an embodiment by which users communicate with the control unit via a mobile phone.

FIG. 12 is flow diagram illustrating the operations between the mobile phones and the control unit.

### DETAILED DESCRIPTION OF THE INVENTION

Various embodiments of the invention are described in detail below. While specific implementations involving electronic mobile devices (e.g., portable computers or mobile telephones) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

It should be recognized that the figures illustrated here simply demonstrate the general environment in which some exemplary embodiments of the present inventions operate. The figures also illustrate exemplary system components and communication schemes. Other variations that accomplish the same purpose may also be used.

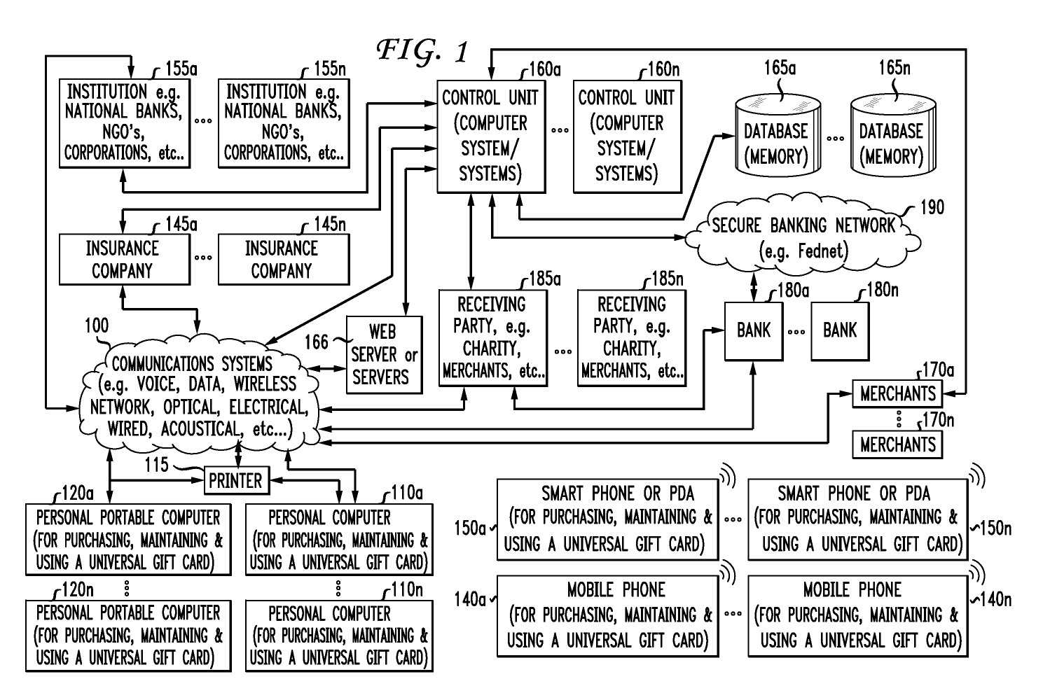

FIG. 1 illustrates the general configuration of the system and its operations, which are broadly illustrated to show the general environment in which the system and method of the present invention operate. The plurality of systems that are illustrated variously interact to perform the many necessary operations of the present invention. The figures show the essential components of the systems and some forms of communications between them. However, it should be recognized that other types of system components that can perform the same tasks would be obvious variations to one of ordinary skill and may be substituted. Likewise, additional networks, paths and branching that cannot be reasonably constructed in a figure may also be used.

Referring now to FIG. 1, reference numeral 100 designates various communication systems or networks. These systems or networks function to allow intercommunication of the various systems involved in the present invention. These various systems or networks include voice, data, wireless, optical, electrical wired, acoustical, or any network that can enable connection between parties for exchange of information. The communication networks may be embodied in a direct line connection between systems.

The communication systems and networks illustrated by reference numeral 100 are any of the following indicated below:
1. Plain old telephone service (POTS) is the voice-grade telephone service that remains the basic form of residential and small business service connection to the telephone network in most parts of the world. The name is a retronym, and is a reflection of the telephone service still available after the advent of more advanced forms of telephony such as ISDN, mobile phones, and VoIP.
2. The public switched telephone network (PSTN) is the network of the world's public circuit-switched telephone networks, in much the same way that the Internet is the network of the world's public IP-based packet-switched networks. Originally a network of fixed-line analog telephone systems, the PSTN is now almost entirely digital, and now includes mobile as well as fixed telephones.
3. Integrated Services Digital Network, is a public end-to-end digital communications network, which has capabilities of signaling, switching, and transport over facilities such as wire pairs, coaxial cables, optical fibers, microwave radio, and satellites, and which supports a wide range of services, as voice, data, video, facsimile, and music, over standard interfaces.
4. DSL or xDSL, is a family of technologies that provides digital data transmission over the wires of a local telephone network. DSL originally stood for digital subscriber loop, although in recent years, the term digital subscriber line has been widely adopted as a more market-friendly term for ADSL, which is the most popular version of consumer-ready DSL. DSL can be used at the same time and on the same telephone line with regular telephone, as it uses high frequency transmission, while regular telephone uses low frequency transmission.
5. A cable modem is a type of modem that provides bi-directional data communication via radio frequency channels on a cable television (CATV) infrastructure. Cable modems are primarily used to deliver broadband Internet access in the form of cable Internet, taking advantage of the high bandwidth of a cable television network. They are commonly deployed in Australia, Europe, and North and South America. In the USA alone, there were 22.5 million cable modem users during the first quarter of 2005, up from 17.4 million in the first quarter of 2004.
6. Power lines have also been used for various types of data communication. Although some systems for remote control are based on narrowband signaling, modern high-speed systems use broadband signaling to achieve very high data rates. One example is the ITU-T G.hn standard, which provides a way to create a high-speed (up to 1 Gigabit/s) Local area network using existing home wiring (including power lines, but also phone lines and coaxial cables).
7. Fiber to the x (FTTx) is a generic term for any network architecture that uses optical fiber to replace all or part of the usual copper local loop used for last mile telecommunications.
8. A WWAN differs from a WLAN (wireless LAN) in that it uses Mobile telecommunication cellular network technologies such as WIMAX (though it's better applicated into WMAN Networks), UMTS, GPRS, CDMA2000, GSM, CDPD, Mobitex, HSDPA or 3G to transfer data. It can use also use LMDS and Wi-Fi to connect to the Internet. These cellular technologies are offered regionally, nationwide, or even globally, and are provided by a wireless service provider, typically on paid basis. WWAN connectivity allows a user with a laptop and a WWAN card to surf the web, check email, or connect to a Virtual Private Network (VPN) from anywhere within the regional boundaries of cellular service. Various computers now have integrated WWAN capabilities (Such as HSDPA in Centrino). This means that the system has a cellular radio (GSM/CDMA) built in, which allows the user to send and receive data. There are two basic means that a mobile network may use to transfer data, the first, a Packet-switched Data Networks (GPRS/CDPD) and the second, a Circuit-switched dial-up connection.
9. Since radio communications systems do not provide a physically secure connection path, WWANs typically incorporate encryption and authentication methods to make them more secure. Unfortunately, some of the early GSM encryption techniques were flawed, and security experts have issued warnings that cellular communication, including WWANs, is no longer secure. UMTS(3G) encryption was developed later and has yet to be broken. These are the same technologies used by cellular phones for data communications.
10. IEEE 802.11 is a set of standards carrying out wireless local area network (WLAN) computer communication in the 2.4, 3.6, and 5 GHz frequency bands. They are implemented by the IEEE LAN/MAN Standards Committee (IEEE 802).
11. A MAN is optimized for a larger geographical area than a LAN, ranging from several blocks of buildings to entire cities. MANs can also depend on communications channels of moderate-to-high data rates. A MAN is owned and operated by a single organization, but it usually is used by many individuals and organizations. MANs are also owned and operated as public utilities. They often provide means for internetworking of local networks. Metropolitan area networks span up to 50 km, and the devices used are modems and/or wires/cables.
12. Bluetooth is an open wireless protocol for exchanging data over short distances from fixed and mobile devices, creating personal area networks (PANs). It was originally conceived as a wireless alternative to RS232 data cables. It can connect several devices, overcoming problems of synchronization.
13. ZigBee is a specification for a suite of high level communication protocols using small, low-power digital radios based on the IEEE 802.15.4-2003 standard for wireless personal area networks (WPANs), such as wireless headphones connecting with cell phones via short-range radio. The technology defined by the ZigBee specification is intended to be simpler and less expensive than other WPANs, such as Bluetooth. ZigBee is targeted at radio-frequency (RF) applications that require a low data rate, long battery life, and secure networking.
14. Communication schemes that fall into the microwave range, which includes most wireless communications systems. Spectral range is between 0.3 GHZ and 300 GHz.
15. Line of site required communications using lasers to transmit information that has been modulated onto the beam.
16. VLF radio waves (3-30 kHz) can penetrate sea water to a depth of approximately 20 meters.
17. Electromagnetic waves in the ELF frequency range (see also SLF) travel through the oceans and reach submarines anywhere. Building an ELF transmitter is a formidable challenge, as they have to work at incredibly long wavelengths: The US Navy's system (called Seafarer) operates at 76 hertz, the Soviet/Russian system (called ZEVS) at 82 hertz. The latter corresponds to a wavelength of 3658.5 kilometers. That is more than a quarter of the Earth's diameter. Obviously, the usual half-wavelength dipole antenna cannot be constructed, as it would spread across a large country.

A plurality of personal computers, indicated by reference numerals 110a-110n, are generally illustrated to communicate via communication networks indicated generally at 100. The personal computers 110a-110n may be any desk top computer system used for communication with another computer or a website. In addition, reference numerals 120a-120n, represent a plurality of personal portable computer systems, which are meant to embody any portable computer system, by which a user is able to communicate with a website. With either of these computer systems, a user or cardholder is able to maintain, obtain, and use universal payment cards. Further, through any of these devices, users use the universal payment card to fund internet purchases or simply to access associated records or access the card themselves in instances where the card stores the value and preferences.

Reference numerals 140a-140n designate a plurality of mobile phones. Reference numerals 150a-150n designate a plurality of smart phones and PDA's (public digital assistant devices). Any of these devices is used, similar to the personal computers, to allow users to perform maintenance, purchasing, and usage operations relating to the universal gift or payment card. This is generally facilitated through additional wireless connections that are generally not implemented in personal computers. However, the devices identified by reference numerals 140a-140n and 150a-150n might additionally contain some means of communicating a record identifier or a means for allowing communications between one of these devices in order to store associated preferences and values.

In accordance with one embodiment, a device configured for communicating a record identifier or storing an associated value and preferences contains a contactless smart chip, as is implemented in contactless smart cards. Other implementations presently known in the industry are also possible.

Reference numerals 145a-145n illustrate a plurality of insurance companies. Insurance companies are generally considered a large source for sales persons and they are generally large givers to philanthropic organizations. Insurance companies may have multiple means of providing such universal gift or payment cards to consumers. For example, an insurance agent may simply, when signing up an individual, ask if an individual is interested in obtaining a card for an additional charge in order to make a donation. The insurance company may further choose to provide a card to all policy holders as gifts or only to new policy holders to thank them for acquiring an insurance policy, thereby providing an incentive. Further, the insurance company may simply choose to send out such cards to individuals based on some frequency, dates, or events. Insurance companies may be configured to have a direct relationship with the control unit, indicated at 160, and the large number of insurance sales people can therefore, provide an efficient way to distribute the cards. In such cases, insurance companies may decide to partner with a specific charity or charities or offers special rates and or arrangements, possibly a 1:1 exchange of funds for funds available to the card holder for purchasing. The connections from the insurance companies 145a-145n to the control unit 160 illustrate the two-way communications between those entities. These communications are over stand communications networks that enable communication with possible buyers, merchants, banks, and other receiving parties.

Reference numerals 155a-155n designate a plurality of institutions. These, much like the insurance companies, are a conduit for individuals to obtain universal gift or payment cards. These institutions may for example, be banks, various non-merchant businesses, etc. In the example of a national bank, the bank may decide that it is necessary to provide further incentives to its customers to purchase bonds. Or the bank may simply attempt to launch a simple campaign in order to raise funds for charities. Any institution may wish to launch a campaign, to accept money and provide a donation. Further, the institutions may also be companies such as telecommunications companies, schools, corporations, small businesses, etc. These institutions are connected by the same type of interfaces and connections that enable advanced communications in a variety of ways that are described above.

FIG. 1 also illustrates a plurality of databases 165a-165n connected to the control unit 160. The control unit 160 comprises a variety of systems and edifices configured to perform operations such as verification, record maintenance, funds dispersal and holding, administration as well as a variety of other tasks. Specifically, as depicted, the control unit 160 is to some degree a main hub of the system. In the case of a record-based system, the control unit 160 is interfaced by users for all the required operations. For example, a user establishes interface with the control unit 160 for initial set up of a universal payment card when a user desires to make changes and for purchases. In the example illustrated here, most systems interface with the control unit 160 through some network or through a direct interface. In the case where the card itself stores the value and settings, certain embodiments require controlled interfacing with the control unit 160, while others only require interfacing at some point for the acquisition of funds. Specifically, in the present embodiment, the control unit 160 communicates with banks via a secure banking network, illustrated by reference numeral 190, to enable a secure way to electronically communicate with banks for financial transactions. The control unit 160 may be operated by a bank, a financial institution, an internet auction site, an internet search engine or any search company or institution, which can provide the required interfacing, administration, and other necessary functions typically performed by the control unit 160. The control unit 160 additionally provides a means via the communications systems and networks 100 for individuals to interface with the control unit 160 as well perform the outlined functions from the personal portable computers 120a-120n, the personal computers 110a-110n, the mobile phones 140a-140n and the smart phones or PDA devices 150a-150n. To acquire a universal payment card, users do not necessarily have to interface with the control unit 160. Rather, other entities or systems interfaced directly or indirectly with the control unit 160 may provide universal payment cards.

Additionally, FIG. 1 illustrates the control unit 160 as interfaced with items 170a-170n, which designate merchants that process purchases by users. At certain times, merchants are required to communicate with the control unit 160. For example, in the case of the record-based system implementation, a merchant would be required to verify available funds before processing a transaction and provide for the accounting of funds to be credited to the merchant and debited from the record, as well as possibly handling the charitable contributions.

In the case where the card itself stores the value and preferences, the system may require immediate interfacing with the control system 160. However, in most embodiments where the value is stored on the card, a merchant may collect the “credits” from the card. Then, at some convenient or designated point, the merchant chooses to interface with the control unit 160 to exchange the “credits” for a preferred currency. Additionally, the merchant would likely interface with the control unit 160 for accounting and record keeping and for dictating possible charitable contributions. The databases 165a-165n interface with the funding institutions when the institutions hold records of accounts and funds.

As illustrated, the banks 180a-180n communicate with the funding institutions via a secure banking network, indicated by item 190. This network is secure and separate from an open network and only accessible to banking institutions. The secured banking networks provide added levels of security and are well known in the art. One example is the federal reserves FedWire. It may be possible to use some other communication means, such as a direct telephone connection or possibly some point-to-point network or even a peer-to-peer network to exercise adequate security measures.

The banks 180a-180n as illustrated in FIG. 1 are similar to institutions 155a-155n, however, they are separately illustrated to show a possible scenario where a receiving party e.g. philanthropic entities, items 185a-185n, hold an account in a possibly non-affiliated institution. In this scenario, money can be sent to the receiving party through numerous means, preferably, an electronic means, though other ways are possible.

For example, a payment intermediary service that facilitates world-wide e-commerce can be used. An account with such an organization can be funded with an electronic debit from a bank account or by a credit card. Recipients of a transfer via this organization can either request a check from it, establish their own deposit account or request a transfer to their bank account.

In the United States, such organizations are licensed as a money transmitter on a state-by-state basis. They are not classified as a bank in the United States, though the company is subject to some of the rules and regulations governing the financial industry including Regulation E consumer protections and the USA PATRIOT Act.

An online payment processing service aimed at simplifying the process of paying for online purchases may also be used. Users store their credit or debit card and shipping information in their processing service account, so that they can purchase at participating stores at the click of a button. Such services also offer fraud protection, as well as, a unified page for tracking purchases and their status.

Such services focus on enabling one-time payments to be made from a purchaser to a merchant. They do not permit the use of stored funds, nor allow payments from person to person.

One such service also has a program, which allows US IRS Certified 501(c)3 Non-Profit organizations to collect donations online, for a fee of 2.9%+$0.30 for donations under $3000, with lower rates for larger donations.

The receiving parties 185a-185n are generally the actual parties receiving the charitable contribution. The main example would be the institution of a charity. These charities provide the universal cards to users in the same way that the institutions 155a-155n provide them as described above. Similarly, the receiving parties 185a-185n choose to configure the universal cards they provide to only execute financial donations to specific charities, in all likelihood, themselves.

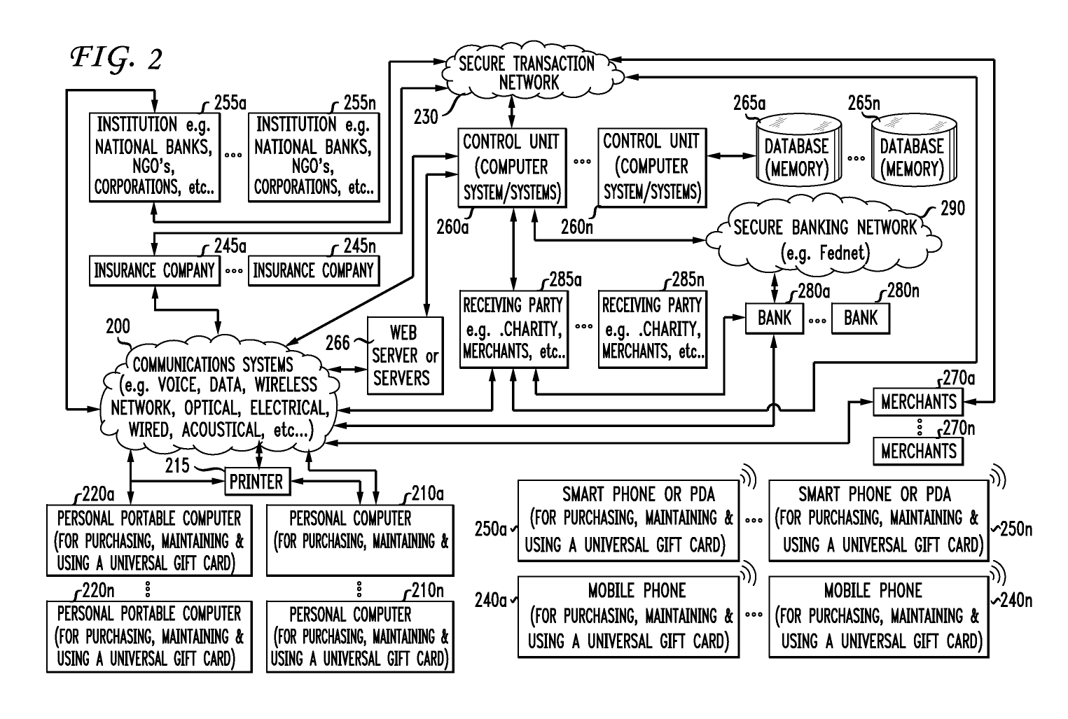

FIG. 2 similar to FIG. 1 illustrates systems and environments in which the present invention operates. However, FIG. 2 presents a specific embodiment of FIG. 1, wherein the communication from the merchants 270a-270n, institutions 255a-255n, insurance companies 245a-245n, and receiving parties 185a-185n, with the control unit 160 is through a secure transaction network, 230. A secure transaction network 239 is a network that is configured as a private network connecting various parties that perform transactions or card configuration with the control unit 160.

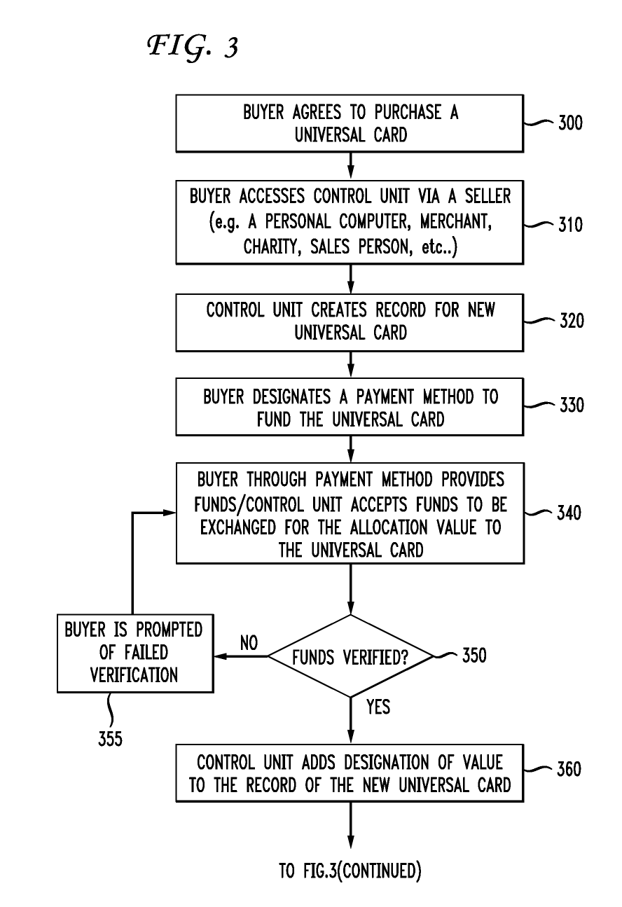

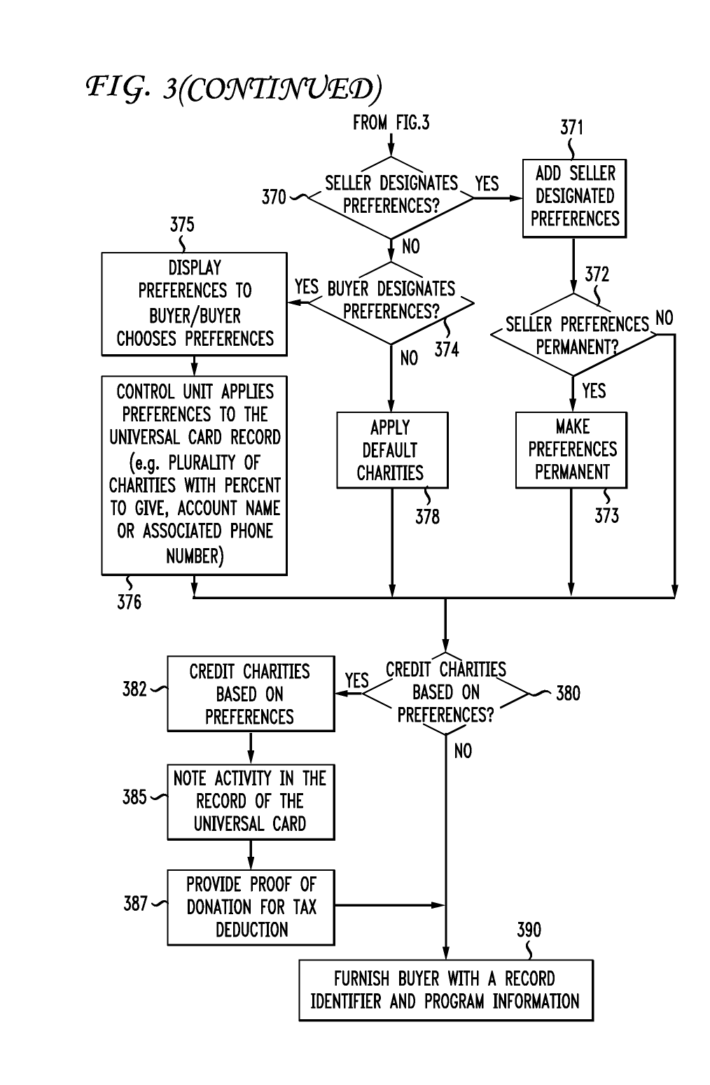

FIG. 3 shows the general process by which a “buyer” obtains and sets up a universal payment or gift card. The “buyer” as mentioned here represents individuals who choose to obtain a card either for their own use or for the purpose of providing it as a gift to another, or an institution that simply chooses to provide the cards to other parties, or the like. The buyer is simply any party that wishes to obtain cards with some designated or pre-paid value.

With reference to FIG. 3, block 300 represents a buyer who agrees to purchase a universal payment or gift card for use with a record-based system. In one embodiment, this step may be a simple act of acknowledging the need of a buyer to obtain a universal gift card for some intended purpose. Additionally, this block represents operations whereby a buyer has determined that a seller provides a card. The seller is any individual or institution as discussed previously with regard to FIGS. 1 and 2, which may provide a card. For example, the institutions, the control unit 160, insurance companies 145a-145n, charities 185a-185n, receiving parties 185a-185n, merchants 170a-170n or perhaps some other holder of an agreement with the control unit 160. Block 310, directly follows block 300 and represents the operation of accessing the control unit 160 by the buyer. This accessing operation may occur in any one of a plurality of ways. The buyer may choose to access the control unit 160 via an internet connection, through some website designed for online sales, via a merchant that accepts the universal payment card, through an institution, an online merchant, via a sales person, through a charity, through a receiving party, through banks, or through any other means that allows the buyer to interface with the control unit 160.

Block 320 represents the operation of the control unit 160, by which it creates a record on the databases 165a-165n to store the value and preferences. The record may take the form of a simple record in a memory system, a complex account, or any data structure that has the capability of storing the necessary information to include, but not be limited to, preferences and a value. Block 330 represents the operation, by which the buyer designates a value that is desired for the universal card and conveys it to the control unit 160. Block 340 represents the operation by which the seller accepts the designated value. The value may be provided by multiple methods of payment, such as with a credit card, hard currency, a debit card, a check, a routing and account number or any other method for proving payment. At decision block 350, the system verifies the funds that were provided to obtain the card. In the case of a credit card, the funds are verified through well known credit card verification schemes. In the case of hard currency, the seller is responsible for providing verification, though the verification may be accomplished by some automated currency verification system. Other methods of payment would likely only be accepted with supported verifications and would be dependent on such. For a check to be accepted, the buyers' identity would likely be verified by a human agent. Of course, this would not provide a verification of funds, as much as it would provide a means of verifying individuals, in order to hold them possibly accountable for any fraud. If the funds are not verified, the system advances to an operation indicated by block 355 where the user is prompted of the failure and requested to input a new source of payment or optionally, abort the process, at which point, the system then returns to block 340. If the verification operation does succeed, the system advances to operations at block 360.

Block 360 represents the step where the control unit 160 stores the designated value into the record that was created, which designates the value that the card can be used to represent and fund. Block 370 is a decision step, which facilitates the situation where the seller determines the preferences of the system, particularly the receiving party or charity. If the seller determines the preferences, the system advances to block 371, where the preferences are set and added to the record. The system then advances to block 372, which is a decision step. At this point, the preferences as defined by the seller are confirmed as permanent preferences. In other words, neither the buyer nor a possible future card holder can change the preferences, such as the receiving charity as defined by the preferences. This operation protects a seller's choice to support a charity that the seller determines should be the recipient. For example, a charity itself could provide the universal gift cards and limit the giving to it. If the preferences are to be made permanent, the system advances to block 373, where they are designated as permanent, by making a note in the record. The system then advances to block 380. If the preferences are not meant to be permanent, the system advances directly to block 380. Block 372 and 373 may be combined into a single operational block 371 whereby the act of modifying the preferences can include the step of designating the preferences permanent. If previously at block 370, the preferences are not to be designated by the seller, the system advances to block 374. Block 374 is a decision step. If the preferences are to be determined by the buyer, the system advances to block 375. At block 375, the system prompts the user with the possible charity selections and accepts the buyer's selections. At block step 376, the system applies the charitable selections to the record and then advances to block 380. At block 275, though the system states displaying and accepting the preferences, the system may simply accept some user input and require no actual displaying. By displaying, the system may simply return an audio signal if the buyer is obtaining the universal card from a seller over a voice line. If the user is not required to set the preferences, the system advances from block 374 to block 378, where default preferences are applied. These preferences may include anything, including but not limited to, null preferences or some such default charity, or even an option that allows a charity to be specified at a later time, possibly by another user such as the card recipient. Additionally, block 374 may involve buyer input, simply to state that they do or do not wish to set preferences. Additionally, at block 375, the buyer may choose to select no charities to be set and leave the charities null.

Block 380 is a decision step. If the charities are to be credited immediately, the system advances to block 382. The charities can only be credited at this time, if charities were designated in the first place. At block 382, the charities are credited based on the preferences. This process may be accomplished in a plurality of ways. The system credits the charities through the control unit 160, which transfers funds between the card's record and a record belonging to the charity. The system may transfer the money to a bank account belonging to the charities. The system may mail the funds to the charity, etc. Block 385 notes the activity of the funding of the charities on the universal card and the system then advances to block 387. In block 387, the system provides proof of a donation when the designated incentive is a charitable contribution for tax purposes. The system then advances to block 390. If the charities are not to be credited in the operation performed at block 380, the system advances to block 390. At block 390, the buyer is provided with an account identifier. The identifier may be furnished to the buyer in a plurality of ways. The ways include, but are not limited to, printing a screen image containing an identifier, such as a string of numbers, a physical card, which is a smart card or a card containing a magnetic strip or a barcode, a simple string of numbers that can be copied, written, or memorized by the buyer. The system additionally provides certain program information. The information could include, but is not limited to, listing participating stores, charities, business and persons or any accepting body of the card. It may also list special offers and provide a website. The information may be communicated by a website or a pamphlet, which would be likely when dealing with sales persons.

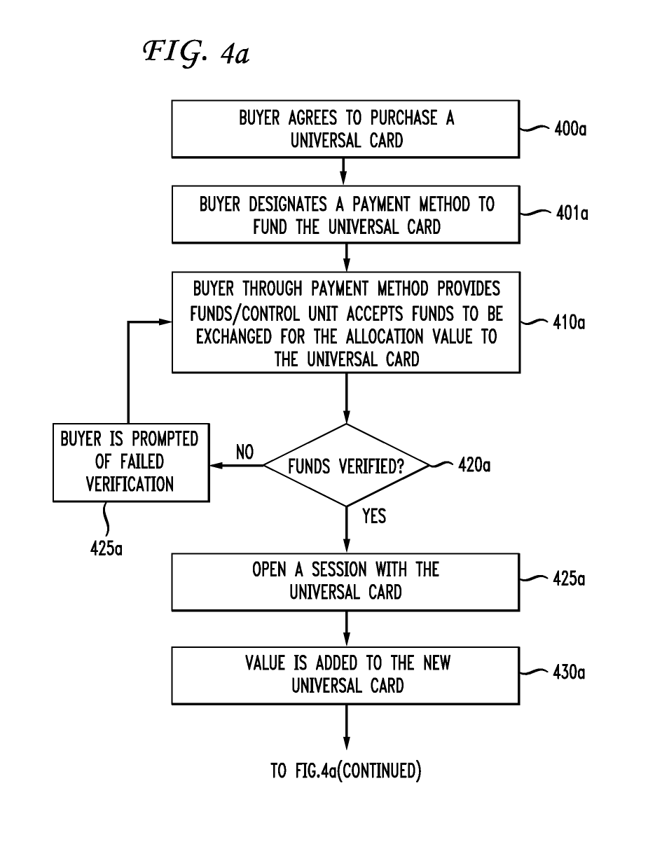

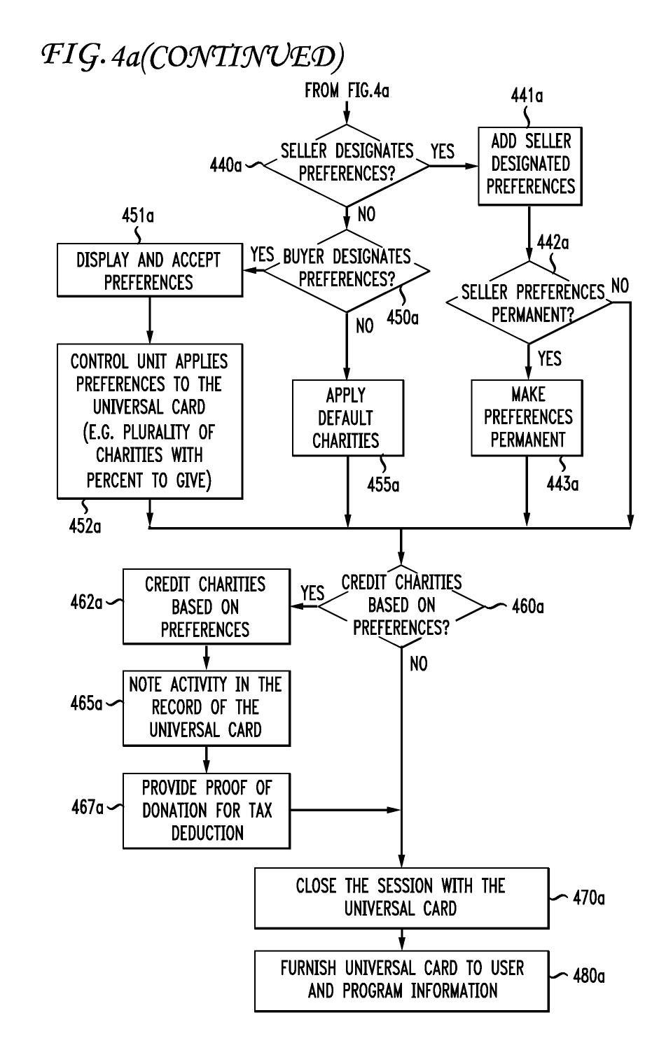

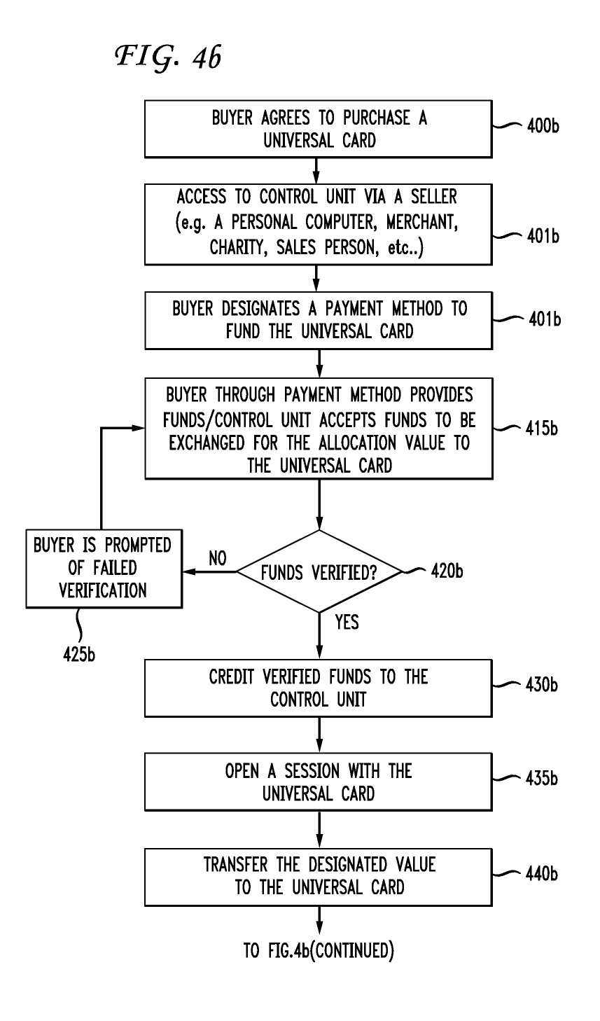

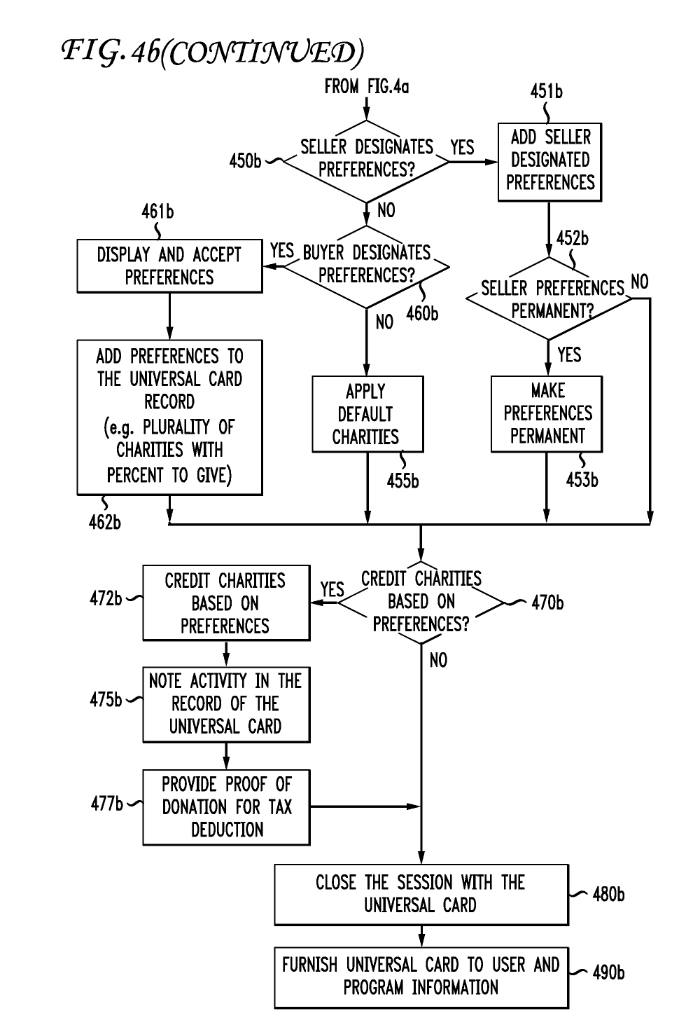

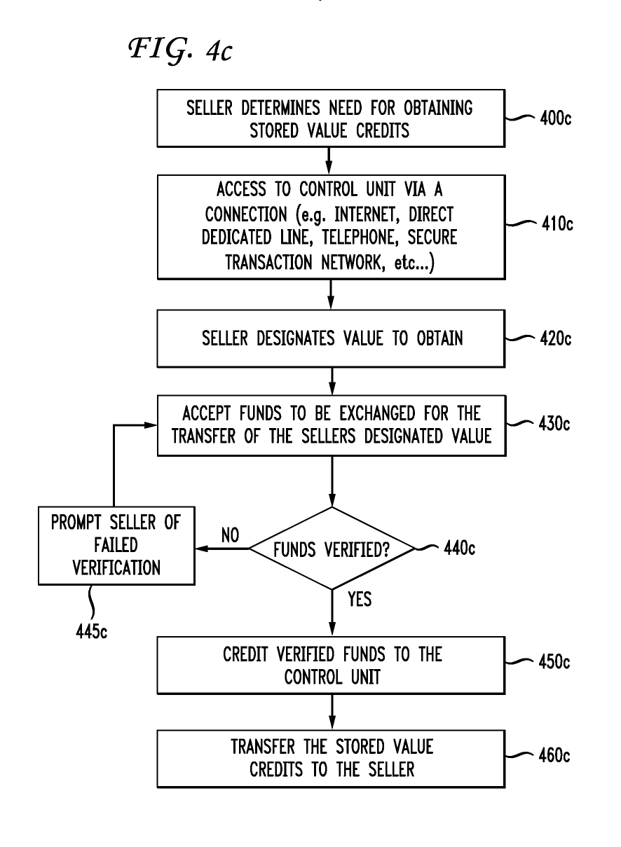

FIG. 4a illustrates a similar process as that illustrated in FIG. 3, different only in that FIG. 3 illustrates a record-based system, and FIG. 4a illustrates an embodiment where the universal payment card itself stores the value and preferences. Specifically, FIG. 4a illustrates the system whereby the users obtain the card without interaction with the control unit 160. More specifically, the system as illustrated in FIG. 4a, represents a situation where the value or “credits” to be placed on the card are already stored and held by the seller.

System operational steps 400a through 420a correspond largely to steps 300 through 350, however, the steps involving the control unit 160, mainly steps 310 and 320, do not have any corresponding steps as the control unit 160 is not necessary in the embodiment illustrated in FIG. 4a. Block 425a illustrates the operation of opening a session with the smart card. This is a necessary security measure to ensure the memory and the stored value on the card. At step 430a, the value is added or transferred directly to the card. This involves taking the “credits” in possession of the seller and transferring them to the card. Steps 440a through 467a correspond to steps 370 through 387 and are similar to the operations described with respect to those steps. Step 470a closes the session with the card. Step 480 is similar to step 390.

FIG. 4b illustrates a process similar to that shown in FIG. 4a, except that, in 4b, instead of having the value transferred from the seller to the card, the value is transferred from the control unit 160. As such FIG. 4b has certain elements from both FIGS. 3 and 4a. Step 400b includes the operation described with respect to steps 300 and 400a. Step 401b is similar to step 310. Step 410b is similar to step 330 and 401a. Steps 415b-425b are similar to steps 410a through 425b as well as steps 340 through 355. Step 430 teaches where the funds are directly credited to the control unit 160 in exchange for the credits of a value established through some exchange rate. This step might be one of accounting, whereby the seller may simply place a credit on its accounting books, acknowledging the need for the transferring of the funds. Steps 435b through 490b are similar to steps 425a through 480a.

FIG. 4c illustrates a process that may be a necessary part of the operations of FIG. 4a. FIG. 4c specifically illustrates the process by which a seller (at possibly a different time from when the buyer obtains a card) connects to the control unit 160 in order to receive “credits” that may be later added to a universal payment gift card.

At step 400c, a seller makes a determination that the seller requires “credits,” which the seller may furnish to buyers of universal payment cards. Step 410c is similar to steps 310 and 401b. In step 420c, the seller designates the value that the seller requires. Steps 430c through 450c are operationally similar to steps 415b through 430b, except that, the seller is prompted in FIG. 4c as opposed to the buyer being prompted in FIG. 4b. In step 460c, the funds or “credits” are transferred from the control unit 160 to the Seller. Step 470c is operationally similar to step 387.

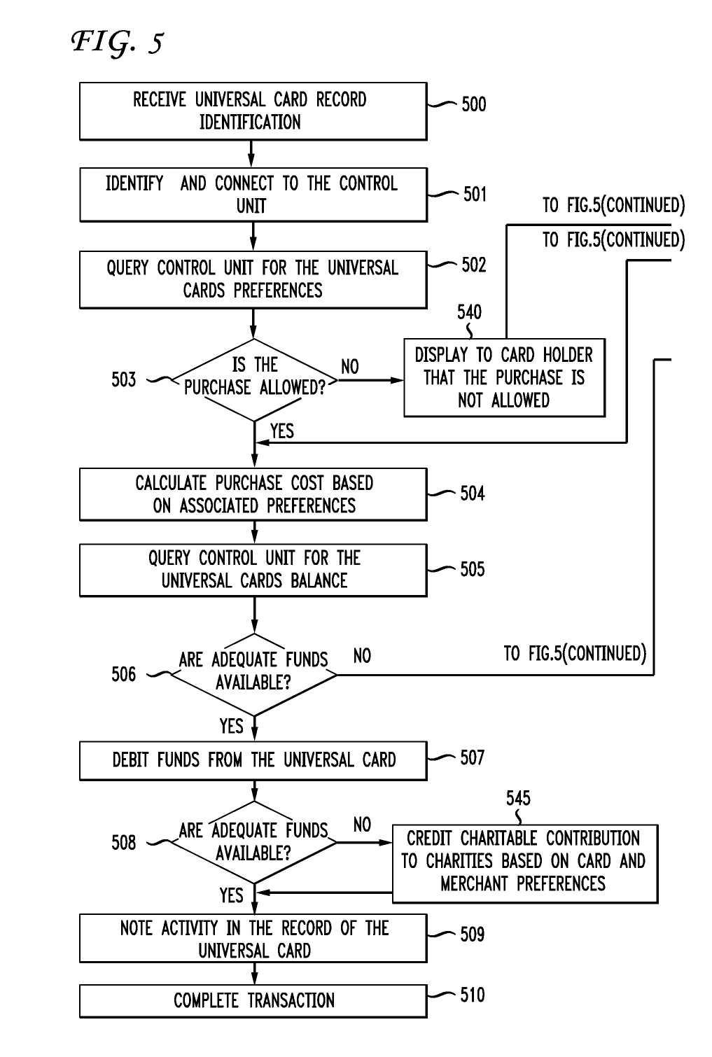

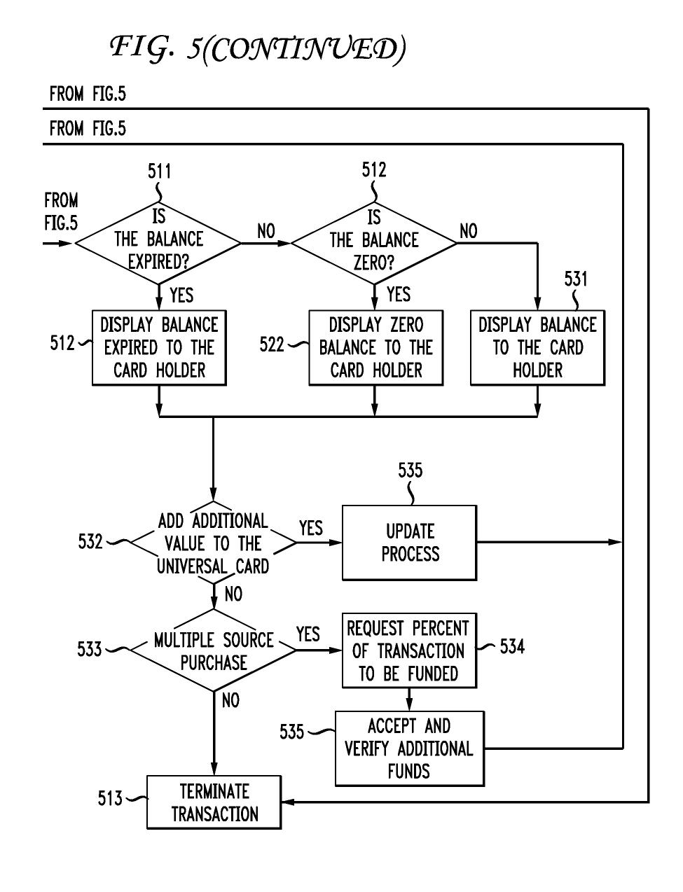

FIG. 5 depicts an embodiment of an aspect of the present invention, the aspect being the general process of a purchase being performed using a record-based system. This process may be carried out by a merchant either in person or over some connection, e.g., an internet purchase or a voice connection with an operator or an automated system. The most general concept of what occurs during this process is that a user is able to, in some way, furnish a merchant with some record identifier, which would optimally be carried on some card, which has some associated record holding some amount of money, preferences and information.

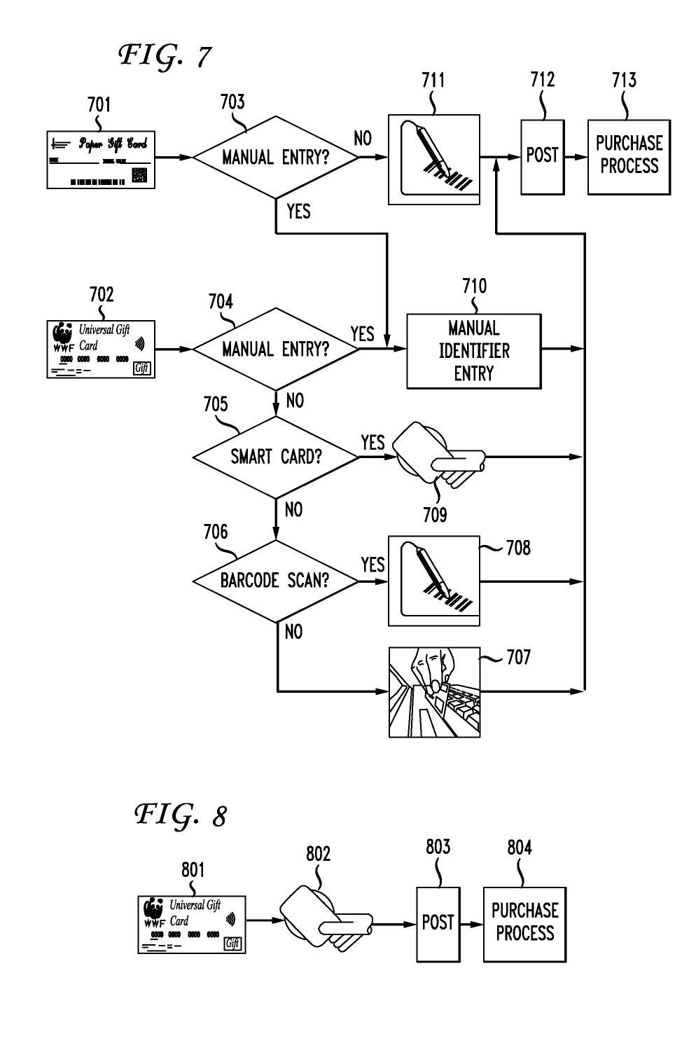

At step 500, the system receives the account identification. This can, as outlined earlier, be performed in numerous ways. Users attempting to make purchases may carry with them a device that can in some way be scanned or interrogated for account identification. FIG. 7 depicts the various methods by which the account identifier may be obtained by the system.

At step 501, based on the account identification, the control unit 160, which maintains the record, is identified and connected. This can be done in a number of ways. One example of verifying identification, may be performed similar to the way by which credit cards are readily identified, based on their account numbers. Additionally, the merchant may choose to simply delegate this task to a service and to pay a service to perform this task. In such case, the merchant would provide the identifying information to the service. In yet another possibility, the device may contain some type of identifier or the identifier may be manually entered. The merchant would then access the control unit 160 via some connection and access the record.

At step 502, the system retrieves the preferences, settings, and various governing data associated with the record. This information is used by the system as previously described to determine a possibly brokered “exchange” rate, as well as, information governing various incentives, particularly describing a charity or charities for the receiving of certain funds associated with the transaction.

At step 503, if the preferences as defined on the record disallow the purchase for some reason, for example, in the event of card restrictions, the system then advances to step 540. A card may be restricted where the merchant, type of merchant, or products have been marked as unauthorized for use. These restrictions may be used by parents or agencies that were the buyers or the providers of the card and want, to some degree, to control what the card may be used to purchase. At step 540, the system alerts the card holder that the transaction is not allowed and indicates the reason why the transaction is not allowed.

At step 504, the system, based on the retrieved preferences and information, calculates the cost of the purchase for the user. It may be that some large merchant, such as Macy's, may offer a preferred rate whereby users will be further motivated to both, use their accounts and patronize the merchant with their business.

At step 505, the system retrieves the current balance associated with a particular universal payment card. This step may be additionally carried out where the system queries the control unit 160 with the amount of the purchase. The control unit 160 then returns an indication whether or not there are adequate funds available and the amount of funds associated with the card. If the funds are not adequate, the system indicates the reason, e.g., the balance of the account has expired or whether the account balance is at zero.

At step 506, if the funds are available, the system continues to step 507. If the funds are not available, the system continues to step 511. At step 511, the system checks to see if the balance has expired. If the balance has expired, the system continues to step 512, where the system returns an indication that the balance has expired and continues to step 532. A test for expiration is only for implementation when such a restriction is required by a particular merchant. A test for expiration is generally not required and funds may simply never expire. If the card is not expired, the system checks to see if the account has a balance of zero at step 521. If so, the account continues to step 522, where the system outputs an indication to the user that the balance is at zero and then continues to step 532. If the balance is not at zero, and the account still holds a balance, but insufficient to cover a purchase, or if the system is not able to retrieve the total balance, or if the balance is no longer stored in the memory of the merchant's systems, the balance is retrieved from the control unit 160, at step 531, and then shown to the user, at step 532. In addition, the system may display the difference between the balance on the device and the cost of the transaction.

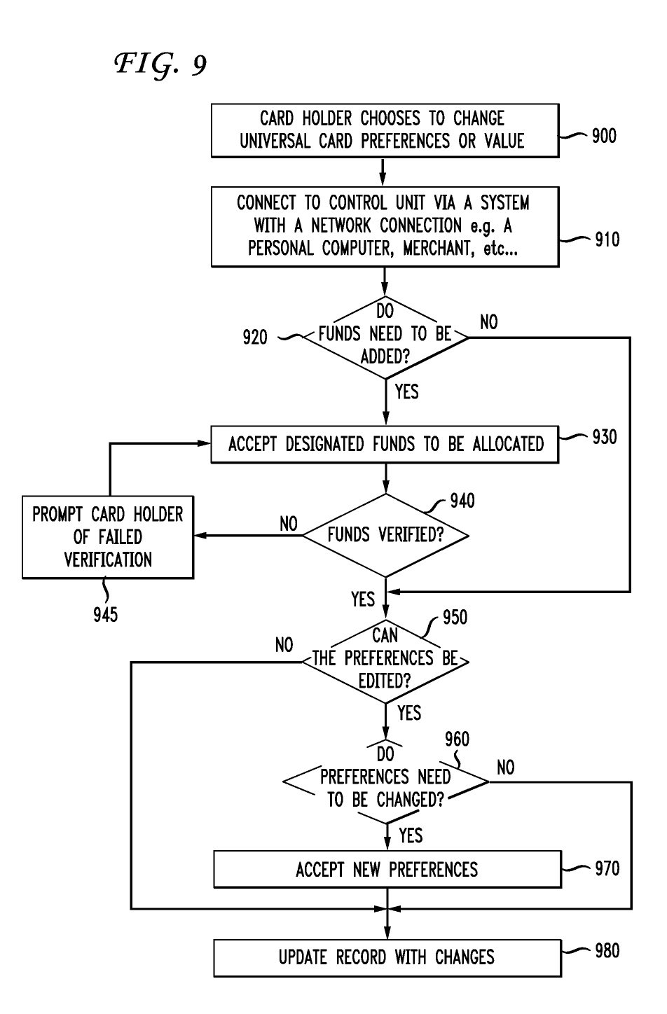

At step 532, the system queries the card holders, as to whether or not the card holders wish to add additional value to the card in order to complete the transaction. If they do, the system advances to step 536, where the update process, similar to that of FIG. 9 is started. The system then returns to step 504. If the card holder does not wish to add value to the card, the system advances to step 533. At step 533, the system queries the card holders whether or not they wish to use more than one source for the transaction. This could be accomplished by using a credit card, cash or any other source of funding to cover the remaining balance that is not able to be covered by the card. If the user doesn't wish to perform the multiple source purchase, the system advances to step 513. If the user does wish to perform the multiple source purchase, the system then continues to step 534 where the user provides the percent of the transaction he or she will fund from an additional source, where the percentage covered by the account must not exceed the amount in the account. Additionally, the system may be configured to accept an amount to be funded instead of a percent or provide a simple setup to fund the purchase with the balance of the account with the rest to be funded by the additional source. The system then advances to step 535, where the user provides the alternate source of funds and where they are also verified. The system then returns to step 504 to re-verify the account. At step 513, the transaction is terminated. Any of the decision blocks may be presented and answered in the user preferences so that no human interaction is needed. Additionally, the system may be configured, in the presence of the inadequate funds, to simply terminate the transaction, possibly notifying the user in such cases.

Furthermore, in yet another embodiment, the system does not verify additional funds for a multiple source transaction. Rather, the merchants perform such a task on their own, outside of the system of the present invention. The system may further simply terminate a transaction and simply return a failed transaction with the reason for it and then allow the merchant to independently perform the tasks of splitting a transaction over multiple funding sources and or adding more value to the device.

At step 507, the funds are debited from the record associated with the universal payment card and credited to the merchant. The crediting may occur by transferring the value from the record to another record at the control unit 160 or simply by dispersing funds to the merchant in some currency, or transferring funds to a merchant's account at a bank in a specified currency, or through some physical means.

At step 508, the system checks to see if, based on account preferences, the designated incentives have been applied, e.g., the designated charity was already credited ( in some specific implementations, this step may be skipped altogether). If the designated incentives have already been provided, the system will continue onto step 509, otherwise, the system advances to operational step 545.

In operational step 545, based on the account preferences, the system provides certain incentives, e.g., crediting a charity with some amount associated with the transaction. Additionally, if the card happens to have no value designated for the charities, the merchant or possibly the control unit 160 provides a default charity to be funded. These funds would likely come from the control unit 160, but may also come from various services employed by the merchants or possibly by the merchants themselves. Further, the system provides a means of showing evidence of the contribution for tax purposes either through a receipt provided by the merchant/vendor or through notation on the card and or account for providing at a later time the evidence for tax purposes. At step 509, the account is noted for the activity and then at step 510, the transaction is completed and ended.

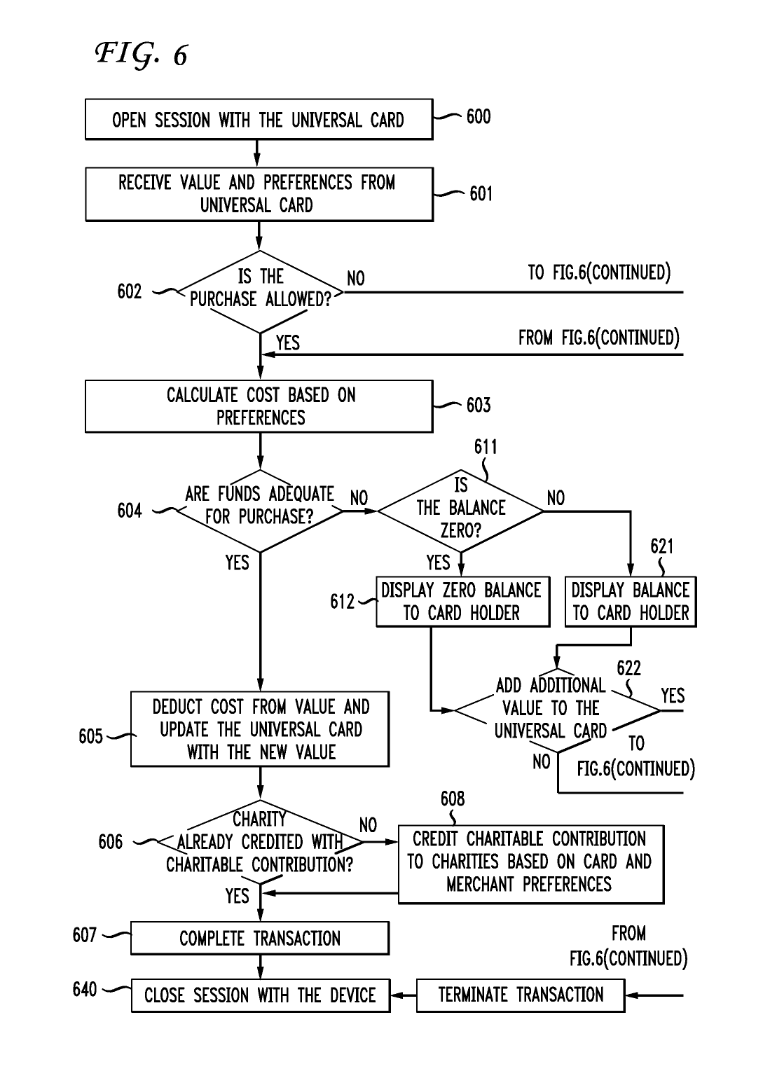

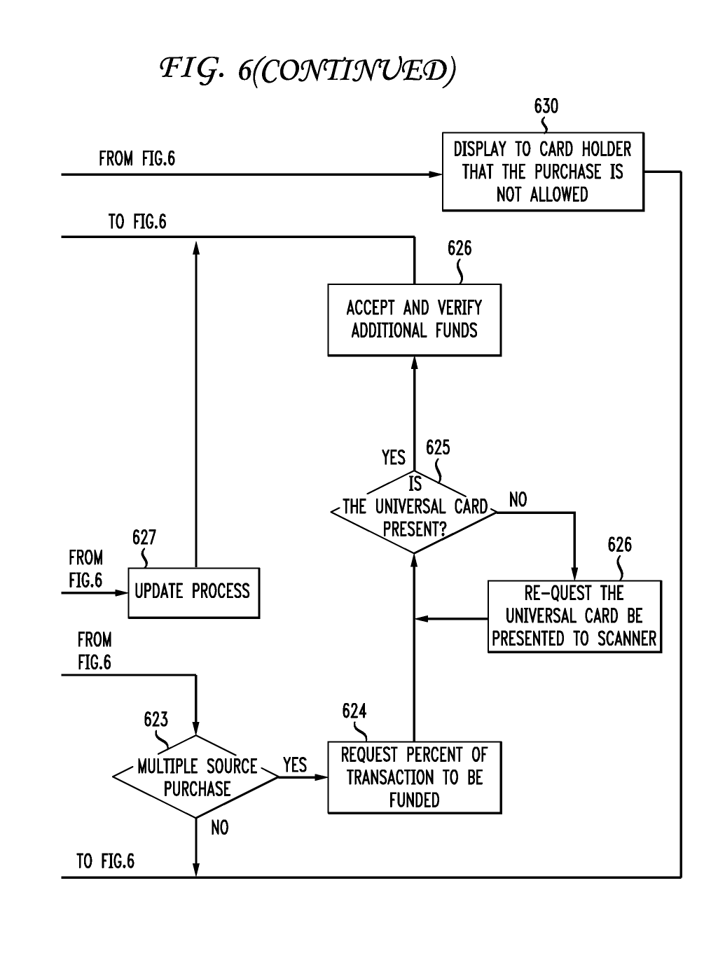

FIG. 6 shows an exemplary embodiment of a purchase process whereby the universal payment card stores the value and preferences on the card. This process closely follows the process as described above regarding FIG. 5 and the account-based purchase process. However, the systems differ in ways that require an explanation of FIG. 6 for illustrative purposes.

Step 600 shows the establishing of a session with the device as similarly outlined for step 435b of FIG. 4b. This operation, as stated previously, allows for secure communication between the device and the system, and follows the connection process, which is later outlined in FIG. 8. Step 601 follows after the opening of a session with the universal card. Specifically, step 601 represents the system reading the value stored on the stored value device as well as the associated preferences and data.

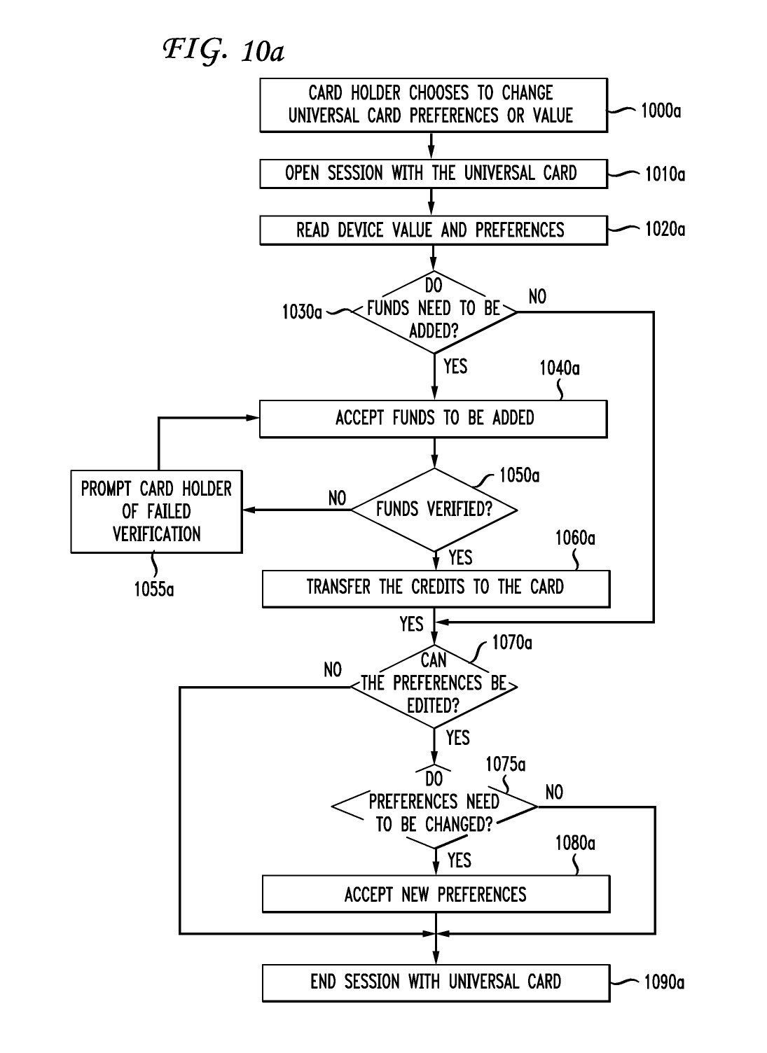

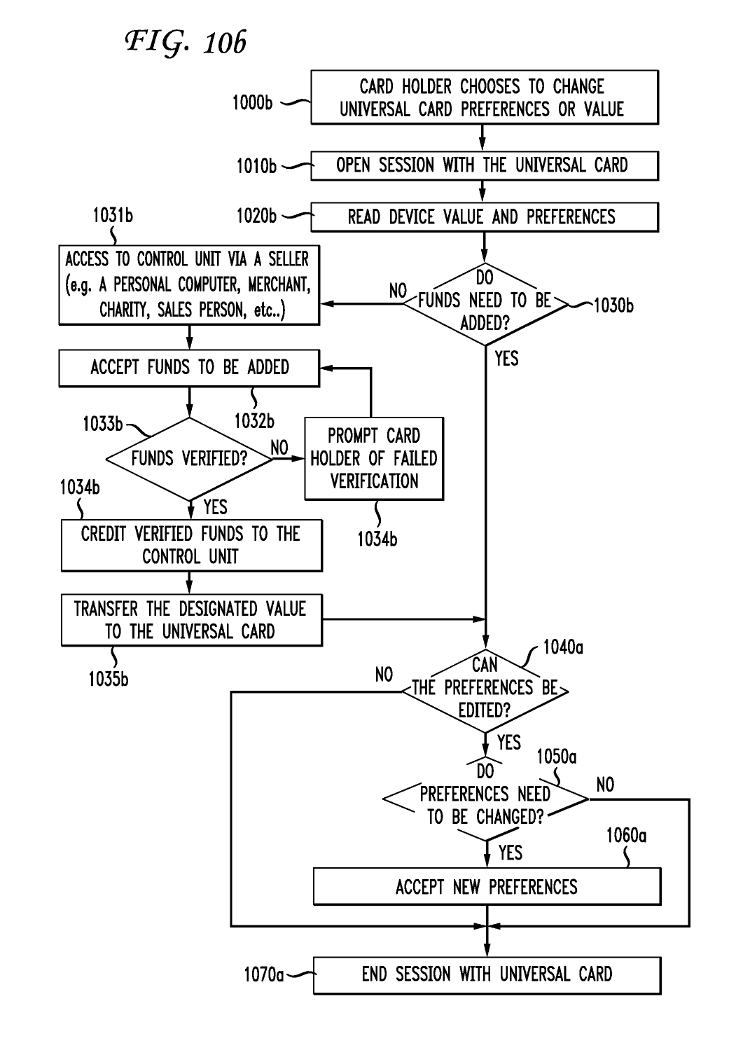

Steps 602 through 604 are operationally similar to steps 503 through 506 and step 630 is similar in operation to step 540. Steps 611 and 612 are similar in operation to steps 511 and 512. Steps 621 through 624 are operationally similar to steps 531 through 534. The system then advances to step 625. Step 625 checks to see if the device is present. This is necessary as the device must be present to perform a transaction. Step 625 included to illustrate that a user, during the purchase process when using a contactless type of device, requires some proximity to maintain a connection, whereby the device might lose its connection with the system. If the device is not present, the system advances to step 626, where the user is requested to present the device to the reader. The system then returns to step 625. When the device is present, the system continues to step 628, which is similar to step 535. The system then returns to step 602 to recalculate the cost based on the entered quantity to be funded by the device. Step 626 additionally reestablishes the session with the device if the device was found to be not present. Step 627 is similar to step 536, but references an implementation similar to that depicted in FIG. 10. Step 613 is analogous to step 513. At step 605, the funds are transferred from the card to the merchant's systems. This optionally may involve the merchants actually routing the funds directly to the control unit 160, though the merchants may choose to hold the funds themselves. Further, at step 605, the funds are deducted from the device memory. This places the value essentially into the possession of the merchant who is processing the transaction and likely providing some service or product to the user. The value could be held by the merchant in what is essentially a stored value device that can then be used by the merchant to store the value provided to them by customers, dispense value to employees and pay for goods and services. The value could possibly also be deposited into some account. The card is then updated with the new value.

Steps 605, 606, 607, and 608 are operationally similar to steps 507, 508, 510 and 545, respectively. Steps 606 and 607 additionally teach a card being updated to the activities, specifically the state of whether or not incentives have been applied based on designated preferences e.g., the designated charity has been funded or not. Step 640 is where the session that was opened in step 600 is closed. This could be handled by the merchants themselves or possibly through an institution providing the value, which the merchant systems interface with, informing them of the purchase.

It should be noted that additionally, as with FIG. 5, all of the branches requiring user interaction may be predefined in the user preferences that are stored in the device. This would simply allow for additional speed in processing transactions. It should also be noted, that even with such a scheme, user preferences could be usurped by the user.

As with FIG. 5, FIG. 6 has many other possible embodiments that are envisioned, all of which are not described here. It would additionally be possible to implement an expiration branch checker as illustrated in FIG. 5. Additionally, as illustrated in FIG. 5, it would additionally be reasonable to have a branch for adding additional value for a transaction where there are inadequate funds. Additionally, all paths may end at the complete transaction block for both FIGS. 5 and 6, as opposed to some paths leading to the terminate transaction block. Additionally, further checks can be inserted to allow for more items that require checking. Certain protections may be added to verify a person's identity, such as requiring a challenge for a pin or some biometric information that can be stored on the stored value device, or in the account in accordance with the network-based system.

FIG. 7 depicts the basic outline of how in the case of a record based system, the record identifier and possibly additional security, general and/or personal information is provided to the merchant systems.

Item 701 represents the account information being contained on a universal payment card. Item 701, in the illustrated example, contain, but would not be limited to, a standard barcode, account number and a smart barcode. It also shows the branding of an associated charity, though the charity or charities associated with the account is not limited to the charity specified on the front or requires a charity to be specified on front. A merchant enters the account number, either manually or through a scanning means.

Block 703 simply identifies a possible decision process. In the case of barcodes, a simple barcode scanner item 711, as is known in the art, is simply implemented to read in the account information into item 712, the point-of-sale terminal (POST). In the event of manual entry, illustrated by block 710, the merchant can either accept or choose to accept, the manual entry. The merchant may also directly enter an account number via a keyboard. This is only necessary, if the card holder is making a purchase over the phone or over the internet, or if a card holder does not have a barcode scanner. Though the account number shown in the figure as indicated by item 701 consists of only numerals, the account number could easily contain alpha numeric characters as in the case of a smart barcode. Additionally, a pin number or password is stored in the record, allowing the card holders to enter in some security code to verify their identity. The system, after reading in the account information, runs the account-based purchase process, as illustrated by block 713 and as shown in FIG. 5.

Item 702 depicts a universal payment card, however, the device is not restricted to such a form. The card may take the form of certain devices embedded in a portable electronic device such as a cell phone or a PDA. In such embodiments, the account information is entered directly from the card through manual entry (block 710) as directed by step 704, or through some automated way. Step 705 is triggered if item 702 is a smart card type of device. Block 709 is meant to represent a digital reader of some design. The reader might function through the use of RFID's in the case of a contactless smart card, or it may be an interface that interfaces with the card through some physical electrical means. Block 706 represents the decision to read in the account identifier from the card using a barcode scanner item 708. Finally, if none of the above methods are chosen, the system can additionally take in the account identifier through a magnetic strip reader 707. All of the above input methods output the account identifier to the POST (block 712) and then begin the purchase process or possibly any other process that requires an account identifier.

To articulate the differences between blocks 701 and 702, block 701 represents some account identifier carrying device that is easily obtained by a person who may possibly simply print the certificate, which contains a barcode or barcodes and an account identifier. Item 702, on the other hand, represents a more advanced card with more advanced requirements. It is possible that a card holder may buy blank cards and have the image printed on the card and programmed all at home, although it is more likely, that a card holder may obtain a card from a merchant or some institution, possibly through a branding philanthropy, whereby the advanced identifying devices can be installed and programmed. In one embodiment, users obtain a device online, whereby they temporarily print out something relating to item 701, while waiting for a device such as item 702 to be mailed to them, which arrives subsequently.

Additionally, it should be noted that there is no preference to the order of the various methods for inputting to obtain the identifier. Rather, the figure is simply meant to show the fact that many choices exist.

FIG. 8 follows the same lines as FIG. 7, but rather, specifically teaches for the case of a universal payment card. Design options are limited in the stored-value device due to communications requirements between the system and the universal payment card. Item 801 follows a smart type of device. Current examples are smart cards, which are well known in the art and have various embodiments such as the SUICA system as used in Japan for various Japanese rail systems, as well as the octopus card as is used in Hong Kong. The system is certainly not limited to being embodied in a card form, but may additionally, be embedded in devices such as cell phones as mentioned previously. The device has some communications capability and preferably some security functionality, specifically, the use of encryption as is well known in the art. The system must then interface with the POST, item 803, through some reader or device, item 802, which is meant to be able to allow for communication between the card and the POST. After the communications have been established, the system enters a purchase process as one example, item 804, as outlined, in FIG. 4, though other processes may take place after the POST receives the identifier information.

FIG. 9 depicts an exemplary embodiment of a flow diagram of the general process for adding value to an account for use in purchases. Additionally, the flow diagram outlines the modification of account preferences for the account. These actions can be performed through the personal computers 110a-110n, personal portable computers 120a-120n, merchants 140a-140n, smart phones or PDAs 150a-150n, or mobile phones 170a-170n.

Step 900 shows a card holder making the determination to add value and/or change the preferences of the card. Step 910 describes the accessing of the control unit 160 as has been previously described. To access the proper record, the system must be first furnished with an account identifier. This identifier can be obtained in a plurality of ways as depicted in FIG. 7.

At step 920 the card, holder is queried as to whether or not funds need to be added. If funds do not need to be added, the system advances directly to step 950. However, if the card holder does intend to add funds, then the system advances to perform the next operation, as indicated by step 930. At step 930, the system then accepts the funds that are to be transferred. This transfer operation is done in any one of a multiple ways. By way of one example, in situations where this transfer operation is conducted at a merchant site, the user simply provides physical or hard currency to the merchant for deposit into his or her account. This operation may also be performed at some type of an automatic teller machine (“ATM”) at a bank or such facility. The user provides an account number by manual entry with the merchant, or by one of the other methods of furnishing account numbers that are described above. This account number may correspond to a credit card or a cash account.

At step 940, the system verifies the funds that are added. This verification operation is performed by various methods depending on the funding source. For example, in the case of a credit card, a standard credit card payment sequence is initiated to both verify the funds and place a debit on the credit account. In the example where cash is used, verification is carried out by the cashier, teller, or ATM type device. The verification operation includes various visual inspections or involves more advanced currency verification means. Once the funds are properly verified, the system continues onto the next operation, indicated by step 950. However, if the funds are not properly verified, the system advances to the next operation indicated at step 945, which provides a prompt to the card holder that the funds were not properly verified. Then, the system returns to the next operation at step 930, where it accepts new funds to be verified. Additionally, at this point, the card holder may decide to exit the process.

At step 950, the system determines whether or not the preferences need to be changed. As previously stated above, the preferences may be designated so they cannot be changed or altered. Preferences are an incentive for vendors of the cards as well as possible incentives to buyers of the cards. If the preferences are not subject to change, the system advances to the next operation at step 980. However, if the preferences are to be changed, the system advances to the next operation at step 960.

At step 960, the system queries the card holders whether they want to alter the preferences. If the card holder chooses not to update or alter the preferences, the system automatically advances to the next operation at step 980. If, however, the card holder wishes to make changes to their preferences, the system advances to the next operation at step 970.

Step 970 accepts the card holder's preference changes. The card holder's preference changes can be entered in a plurality of ways. One way would be for a card holder to interface with the system through their personal computer over the internet enabling it so that they may manually enter in their preferences. Another method may be as previously mentioned, in the presence of a merchant, where the card holder would inform the merchant of the preferences that are desired by the card holder and to be applied, or through the ATM type device mentioned previously. The system then advances to step 980, where all changes are submitted to the record and executed. By this, the record and thus, the card is updated. Additionally, in certain embodiments, the operation indicated by step 980 is omitted, and instead, the system updates the account as it performs the operations indicated by steps 940 and 970. At step 980, the system further confirms with the user, the changes before committing them and allowing for edits to the changes.

The above embodiment described here is only one possible embodiment included for illustrative purposes. The embodiment described so far is illustrated to perform linear operations and has a serial structure. Another embodiment performs the tasks concurrently or at the same time or has the user enter into a form on the system interfacing with the account. The information would then be able to follow the same flow without user interaction, or in a more concurrent manner. One of the main advantages of allowing a merchant or facility to facilitate the changing of features to an account is that it allows for the system to be used in areas where users have little to no access to a network in order to access their accounts. This is especially useful in third world markets where perhaps merchants are a user's only gateway to access connectivity.

FIG. 10 illustrates a process similar to the process shown in FIG. 9, but instead of being relevant to a record-based implementation, FIG. 10 illustrates where the universal payment card stores the value and preferences. This process follows that described previously for FIG. 9, which illustrates using a record. FIG. 10, however, holds distinct differences that are included for further illustrative purposes. There are additionally, two parts to FIG. 10, FIG. 10a and FIG. 10b. FIG. 10a, like FIG. 4a illustrates the situation where a universal payment card, which stores a value, does not require interfacing with the control unit 160. Similarly, FIG. 4b illustrates a situation where the system requires communication with the control unit 160.

Step 1000a is similar in operation to step 900. Step 1010a illustrates establishing a connection and opening a session with a smart chip used to facilitate the functionality of the card. The communication may be established through contacts or may be made wirelessly. As is well known in the art, encryption and decryption can be carried out by the device in conjunction with the system to properly verify the device and its validity. Often times, as is known in the art, such devices contain a dedicated encryption/decryption chip.

After the session opens as illustrated by the operation in step 1010a, the system advances to reading or determining the card's value and preferences as is indicated at step 1020a. Steps 1030a through 1050a perform similar operations as steps 920 through 940. At step 1060a, the system transfers the credit from some vendor or merchant with whom the operation is performed. Steps 1070a through 1080a are completely similar in operation to steps 950 through 970.

The final step of the process is ending the currently open session with the universal payment card, indicated by step 1080a. This is a security measure to attempt to ensure the security of the funds stored, represented and information stored on the device.

FIG. 10b is very similar to FIG. 10a, however, it includes certain steps that require communications with the control unit 160. All of the steps are similar in operation with certain steps of FIG. 10a except for, steps 1031b and 1034b. Step 1031b teaches the card holder interfacing with the control unit 160. Step 1034b, illustrates the operation of crediting the provided funds to the control unit 160, which is in exchange for obtaining the “credits” remaining on the universal card. Steps 1000b through 1030b are similar in operation to steps 1000a through 1030a. Steps 1032b through 1034b are similar in operation to steps 1040a through 1050a. Steps 1035b through steps 1070b are similar in operation to steps 1060a through 1090a.

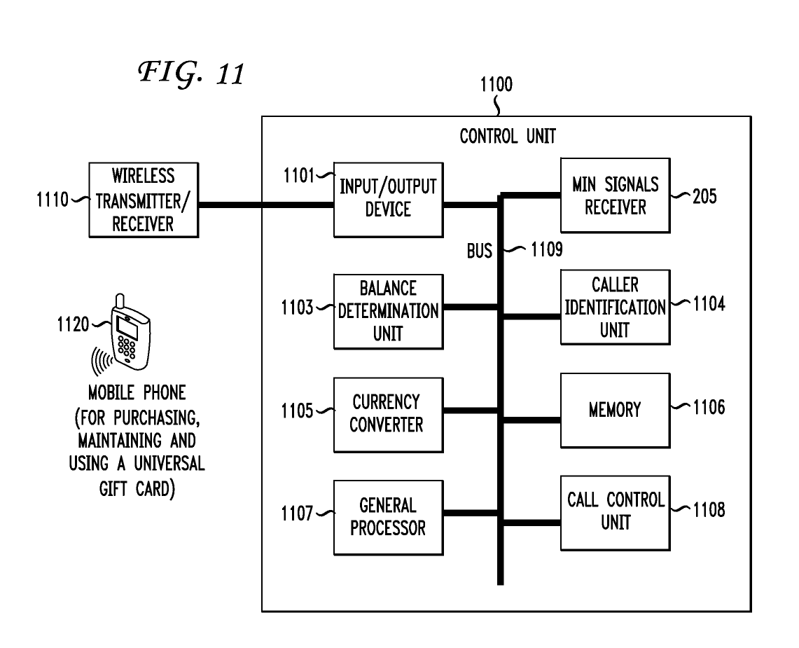

FIG. 11 illustrates a mobile phone designated by reference numeral 1120, a control unit designated by reference numeral 1100, and a Wireless Transmitter/Receiver (Tx/Rx), designated by reference numeral 1110. The control unit 1100 contains various components, which are either virtually implemented or implemented in hardware and are connected by a bus 1109, which is one illustrated means of interconnecting the components. The bus 1109 may be a physical bus or may take various forms of memory communication, such as registers having shared access by each component, kernel level control of resources, or any means of exchanging information within the system.

Reference numeral 1101 designates an input/output device, which generally is implemented in a mixed hardware and software medium, allowing for the interfacing of a system with an external environment, including, but not limited to modems, sound cards, networking devices, or video input/output devices.

Reference numeral 1102 designates a MIN (Mobile Identification Number) signals receiver, which through the use of the MIN signal that are received, uniquely identifies a cellular customer.

Reference numeral 1103 designates a caller identification unit, which based on input from the caller or signals that are provided by the device, identifies a caller. Such signals include calling number signals or MIN numbers from the MIN signal receiver. In the case of landlines, automatic number identification signals (ANI) may be used. Further, users may identify specific identifying information as apposed to following an automated scheme. After receiving the callers' information the, the caller identification unit interfaces with the memory 1106. The memory 1106 stores all information for the control unit including database and user information, in order to identify the caller using the information provided.

Reference numeral 1108 designates a call control unit, which is required for actually interfacing with the caller and includes various automated query and response units and determines the nature of phone calls before carrying out any necessary transactions.

Reference numeral 1103 is a balance determination unit, which is utilized after obtaining the callers identity to determine the caller's balance. Reference numeral 1105 designates a currency converter, which is utilized for the conversion of credits and currencies to the desired credits and currencies. Reference numeral 1107 is a general processor, which runs all the applications and programs on the control unit and handles all related overhead. Reference numeral 1107 may be used to run any and all of the identified components of the control unit.

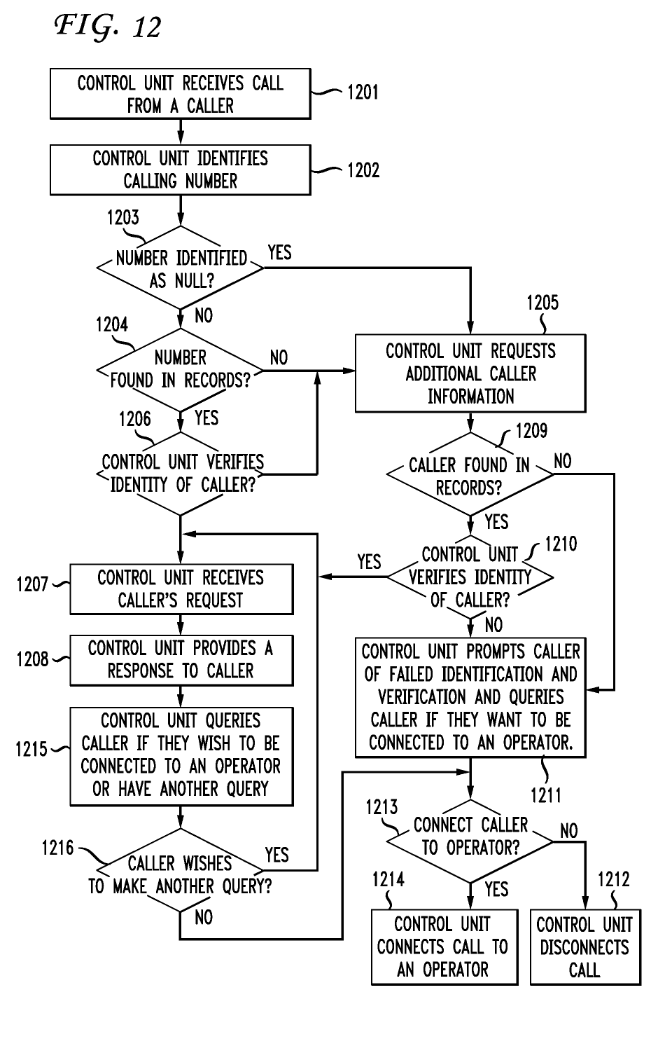

FIG. 12 is a flow diagram for the process of a caller trying to contact the control unit for some query. In step 1201, the control unit illustrates receiving a call from a caller. The control unit then identifies the calling number, through ANI (Automatic Number Identification), or by obtaining a MIN or some other scheme provided by a communications provider. If the calling number is un-identifiable, it is simply considered a NULL value. In step 1203, an identified number is tested to determine if it was identified as being NULL (meaning unidentifiable). If the number was identified as NULL, the system continues on to step 1205, wherein the control unit requests caller information from the user. If the number identified was not NULL, the system advances to step 1204, wherein the system attempts to match the identified number with a record stored by the system. If a record is not identified, the system proceeds to step 1205, to acquire further user information. If a user is identified, the system advances to step 1206.

In step 1205, the system requests the user to provide additional information. This information may include, but is not limited to, address information, name, phone numbers, social security numbers, or any such identifying information collected by the control unit. The system then advances to step 1209, which attempts to find a record for the caller based on the information provided. If the record is found, the system advances to step 1210. If it fails, the system advances to step 1211.

In step 1206, the system attempts to verify the caller's identity. This is in case a caller is calling from a number that has multiple identified records or if a person is calling from a number with an identified record that is not theirs. The identification process may be carried out in a variety of well-known ways. This also confirms that the person calling, even if from an authorized number, is who he or she purports to be. If the identity is verified the system advances to step 1207. If not, the system advances to step 1205.

Step 1209 is the same as step 1204, but if it fails to find a record, the system advances to step 1211. If it succeeds, the system advances to step 1210. Step 1210 is the same as step 1206, but if it fails to verify the caller the system advances to step 1211. If it succeeds, the system like in step 1206, advances to step 1207.

At step 1207, the system receives a caller's request. This is one of any number of requests, such as “what is my balance?” The system may also present the user with a variety of options from a menu. The control unit then provides a response to the caller's query at step 1208. The control unit then queries the callers, at step 1215, if they would like to be connected to an operator or if they have another query. The system then advances to step 1216. At step 1216, if the caller has another query, the system returns to step 1207. If not, the system advances to step 1213. At step 1213, if the call is to be connected to an operator, the system advances to step 1214, where the call is connected to an operator. If not, the control unit disconnects the call at step 1212.

At step 1211, the callers are prompted that the system has failed to verify or identify their identity and informs them that they can be connected to an operator and is queried if they wish to be. The system then advances to step 1213.

As has been previously stated, the above systems depict non-parallel paths and single step operations to perform their necessary functions. The steps could be implemented in other ways and could possibly be performed in different orders. The drawings and descriptions are included for illustrative purposes.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

What is claimed is:

1. A method of providing pre-payment for goods and services in commerce based on providing a universal payment card associated with a pre-established balance account, the method comprising the steps of:
establishing a balance account that has an associated value and that includes a designation of user preferences, where the balance account is maintained by some institution and providing a universal payment card associated with the balance account to a consumer;
facilitating consumer use of the universal payment card, whereby the consumer is able to furnish one or more merchants with account identification in order to request that a merchant access the balance account and apply at least some portion of the associated value toward a purchase transaction of one or more goods or services or both; and
applying one or more incentives to the purchase transaction.

2. A method as recited in claim 1, where the merchant accesses the balance account through a network.

3. A method as recited in claim 2, wherein the user uses a certificate, with a printed barcode to identify the balance account to the merchant, in order for the merchant to scan the barcode to obtain account information.

4. A method as recited in claim 2, wherein the user uses a card type of object, which carries the account information encoded in a magnetic strip, which the merchant can read through the use of magnetic strip reading machine to obtain the account information.

5. A method as recited in claim 2, wherein the user uses a device containing a smart chip, where the merchant interfaces with the chip in order to obtain the account information.

6. A method as recited in claim 5, where the smart chip is a contactless chip, whereby the chip is interfaced through a wireless means.

7. A method as recited in claim 5, where the smart chip requires some contact to allow for its interfacing.

8. A method as recited in claim 2, where the user provides the account balance information, in order to be manually entered by the merchant.

9. A method as recited in claim 5, where the chip is installed in some card.

10. A method as recited in claim 6, where the chip is installed in some card.

11. A method as recited in claim 6, where the chip is installed in some portable electronic device.

12. A method as recited in claim 2, where the network is a secure transaction network.

13. A method as recited in claim 1, where one of a possible plurality of incentives is to offer a special preferential exchange rate for the associated value of the account and with the currency that the merchant is using.

14. A method as recited in claim 13, where the preferential exchange rate is offered based on user preferences.

15. A method as recited in claim 1, where one of the incentives is to donate an amount of money associated with the transaction to a designated charity.

16. A method as recited in claim 15, where the designated charity is determined by the user's preferences.

17. A method as recited in claim 1, wherein one of the incentives is to add points to the balance account based on purchases.

18. A method as recited in claim 17, where the points are determined by the user preferences.

19. A method as recited in claim 1, wherein one of the incentives is to provide value back based on purchases.

20. A method as recited in claim 19, wherein the value back is determined by the user preferences.

21. A method as recited in claim 1, wherein the user adds value to the account by adding funds or adds or edits the preferences by interfacing with the account.

22. A method as recited in claim 21, wherein the user interfaces with the account over a network.

23. A method as recited in claim 22, wherein the user, through an electronic system, interfaces with the account and provides a funding source, from which funds are taken.

24. A method as recited in claim 23, wherein the funding source is a credit card.

25. A method as recited in claim 23, wherein the funding source is a debit card.

26. A method as recited in claim 23, wherein the funding source is a bank account number and routing number.

27. A method as recited in claim 23, wherein the electronic system is a personal computer.

28. A method as recited in claim 23, wherein the electronic system is a portable electronic device.

29. A method as recited in claim 23, wherein the electronic system is an ATM type of device.

30. A method as recited in claim 29, wherein the funds provided to an ATM are hard currency.

31. A method as recited in claim 23, wherein the electronic system is a merchant's system.

32. A method as recited in claim 23, wherein the funds provided to the merchant's system may additionally be hard currency.

33. A method as recited in claim 23, wherein the electronic system is a bank system.

34. A method as recited in claim 33, wherein the funds provided to the bank system may additionally be hard currency.

35. A method as recited in claim 1, wherein the value that the user provides from the account is transferred to an account owned by the merchant.

36. A method as recited in claim 1, wherein the value that the user provides from the account is exchanged for a currency of the merchant's choosing and transferred to a bank account owned by the merchant.

37. A method as recited in claim 1, wherein the value that the user provides from the account is exchanged for a hard currency and mailed to the merchant.

38. A method as recited in claim 1, wherein the value that the user provides from the account is provided to the merchant through a check representing the value in the currency of the merchant's choosing and mailed to the merchant.

39. A method of providing a payment method based on a pre-established balance stored on a stored value device, the method comprising:
providing a stored value device for use for payment by users, the stored value device configured to store user preferences and wherein the stored value device has an associated value;
wherein through a merchant, a user is able to furnish the merchant with the stored value device in order to request that a merchant access the stored value device and extract an amount of the associated value in order to purchase goods and or services; and
applying one or more incentives based on purchases.

40. A method as recited in claim 39, wherein the stored value device contains a smart chip, which stores the value and the preferences, as well as handling means for securing the data.

41. A method as recited in claim 40, wherein the smart chip requires some physical contact to allow it to be interfaced with other systems.

42. A method as recited in claim 40, wherein the smart chip interfaces with systems through a wireless means.

43. A method as recited in claim 40, wherein the stored value device is a card.

44. A method as recited in claim 40, wherein the stored value device is a portable electronic device.

45. A method as recited in claim 40, wherein one of a possible plurality of incentives is to offer a special preferential exchange rate for the associated value of the device and with the currency that the merchant is using.

46. A method as recited in claim 45, wherein the preferential exchange rate is offered based on the user preferences.

47. A method as recited in claim 40, wherein one of the incentives includes donation of an amount of money associated with the transaction to a designated charity.

48. A method as recited in claim 47, wherein the designated charity is determined by the user preferences.

49. A method as recited in claim 40, wherein one of the incentives is to add points to the device based on purchases.

50. A method as recited in claim 49, wherein the points are determined by the user preferences.

51. A method as recited in claim 40, wherein one of the incentives is to add value back on to the device based on purchases.

52. A method as recited in claim 51, wherein the value back is determined by the user preferences.

53. A method as recited in claim 40, wherein the user adds value to the device by providing funds or adds or edits the preferences by interfacing with the device and an exchange party.

54. A method as recited in claim 53, wherein the exchange party is a banking institution.

55. A method as recited in claim 53, wherein the exchange party is another party holding value for a stored value device.

56. A method as recited in claim 55, wherein the party holding value for a stored value device is a merchant.

57. A method as recited in claim 53, wherein the user through an electronic system interfaces with the device with the exchange party and provides a funding source, from which to provide funds.

58. A method as recited in claim 57, wherein the funding source is a credit card.

59. A method as recited in claim 57, wherein the funding source is a debit card.

60. A method as recited in claim 57, wherein the funding source is a bank account number and routing number.

61. A method as recited in claim 57, wherein the electronic system is a personal computer.

62. A method as recited in claim 57, wherein the electronic system is a portable electronic device.

63. A method as recited in claim 57, wherein the electronic system is an ATM type of device.

64. A method as recited in claim 63, wherein the funding source can be a hard currency.

65. A method as recited in claim 57, wherein the electronic system is a merchant's system.

66. A method as recited in claim 65, wherein the funding source can be a hard currency.

67. A method as recited in claim 57, wherein the electronic system is a bank system.

68. A method as recited in claim 67, wherein the funding source can be a hard currency.

69. A method as recited in claim 40, wherein the merchant takes the value and holds the value in some type of stored value device.

70. A method as recited in claim 40, wherein the merchant takes the value and puts it in an account.

71. A method as recited in claim 69, wherein the value can be directly used like a stored value device.

72. A method as recited in claim 70, wherein the account is a stored value account.

73. A method as recited in claim 70, wherein the account is a bank account.
